(19) United States
(12) Patent Application Publication
(10) Pub. No.: US 2026/0312941 A1
(43) Pub. Date: Oct. 8, 2026

(54) HARDWARE ARCHITECTURE FOR EFFICIENT INLINE IPSEC IN HYBRID PLATFORM

(71) Applicant: Cisco Technology, Inc., San Jose, CA (US)

(72) Inventors: Feng Cao, Fremont, CA (US); Shuxian Lou, San Jose, CA (US); Jie Chu, Los Altos, CA (US); Harikrishnan Pillai, San Jose, CA (US)

(21) Appl. No.: 19/170,297

(22) Filed: Apr. 4, 2025

(51) Int. Cl. H04L 9/40; H04L 69/22

(52) U.S. Cl. CPC H04L 63/0428; H04L 69/22

(57) ABSTRACT

A system and method are provided using a hybrid platform that combines hardware and software solutions for securely processing data packets at high data rates. A classifier (e.g., content addressable memory (CAM) for inbound traffic or packet processing elements (PPE) software on a core processor for outbound traffic) classifies the security association (SA) of a data packet based on characteristics of the data packet (e.g., 5-tuple, etc.) and encodes the SA in a customized header of the data packet before the packet is sent to a crypto device (CD). The CD uses the SA in the customized header to perform a cryptography operation and then removes the customized header or clips the SA from the customized header before forwarding the packet to its destination.

### TECHNICAL FIELD

The subject matter of this disclosure relates in general to the field of computer networking, and more particularly to a hybrid software-hardware platform for securely routing data at high data rates through tunnels of an overlay network.

### BACKGROUND

Software defined wide area network (SDWAN) and service provider wide area network (SPWAN) technologies continue to evolve and operate at ever-increasing data rates. For example, emerging technology for SPWAN can result in core functions operating at more than 400-Gbps. Similarly, emerging technology for SDWAN can result in functions operating at more than 50-Gbps for intelligent queue definition function (IQDF) for next-generation platforms. IQDF can include, for example, Internet protocol security (IPSec), quality of service (QoS), deep packet inspection (DPI), and flow and forwarding (FnF) functions. IQDF can refer to network traffic management that intelligently defines and manages queues for different types of traffic based on priority or characteristics (e.g., different types of traffic in a QoS framework).

These high data rates can present various challenges. For example, although application-specific integrated circuits (ASICs) can provide higher-speed operations, providing the desired functionality and speed in a single ASIC can be expensive. Further, software running on one or more processors, such as CPUs and GPUs, faces challenges operating at the specified data rates. Hybrid solutions face challenges with coordinating the disparate functions that are divided between the software and hardware solutions.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram of an example of a hybrid platform for packet processing in accordance with some embodiments.

FIG. 2A illustrates an example of an outbound ethernet frame with a customized crypto device (CD) header in accordance with some embodiments.

FIG. 2B illustrates an example of the customized CD header in accordance with some embodiments.

FIG. 2C illustrates an example of an outbound ethernet frame after encrypting the payload in accordance with some embodiments.

FIG. 2D illustrates an example of an outbound ethernet frame after encrypting the payload and clipping the customized CD header in accordance with some embodiments.

FIG. 3 illustrates a flow diagram for an example of a method for outbound traffic using an express path in accordance with some embodiments.

FIG. 4 illustrates a process flow of an example for processing outbound traffic using an express path in accordance with some embodiments.

FIG. 5A illustrates an example of an inbound ethernet frame in accordance with some embodiments.

FIG. 5B illustrates an example of an inbound ethernet frame with a first customized CD header before decryption processing in accordance with some embodiments.

FIG. 5C illustrates an example of the first customized CD header in accordance with some embodiments.

FIG. 5D illustrates an example of an inbound ethernet frame with a second customized CD header after decryption processing in accordance with some embodiments.

FIG. 5E illustrates an example of the second customized CD header in accordance with some embodiments.

FIG. 6 illustrates a flow diagram for an example of a method for inbound traffic using an express path in accordance with some embodiments.

FIG. 7 illustrates a process flow of an example for processing inbound traffic using an express path in accordance with some embodiments.

FIG. 8 illustrates a flow diagram for an example of a method for inbound traffic using a fallback path in accordance with some embodiments.

FIG. 9 illustrates an example of a high-level network architecture in accordance with some embodiments.

FIG. 10 illustrates an example of a network topology in accordance with some embodiments.

FIG. 11 illustrates an example of an overlay network on an underlay network in accordance with some embodiments.

FIG. 12 illustrates an example of an operation of a protocol for managing an overlay network in accordance with some embodiments.

FIG. 13 illustrates a block diagram of an example of a computing device in accordance with some embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In some aspects, the techniques described herein relate to a method for efficiently processing network data packets, the method including: classifying, at a classification processor, a security association of a data packet based on one or more characteristics of the data packet; encoding, in a header of the data packet, cryptograph information representing the security association; sending, to a crypto device from the classification processor, the data packet together with the cryptograph information in the header of the data packet; performing, by a cryptography processor of the crypto device, a cryptography operation on the data packet based on the cryptograph information in the header of the data packet; and removing the cryptograph information from the header of the data packet before transmitting the data packet to a destination of the data packet.

In some aspects, the techniques described herein relate to a method, wherein removing the cryptograph information from the header of the data packet is performed by the crypto device after performing the cryptography operation.

In some aspects, the techniques described herein relate to a method, wherein: the data packet is part of inbound traffic received at a hybrid platform for packet processing, and the hybrid platform includes a general processor, a routing device, and a hardware accelerator including the crypto device, wherein the general processor is programmed with packet processing software.

In some aspects, the techniques described herein relate to a method, wherein: the data packet is part of inbound traffic, the cryptography operation includes decrypting a payload of the data packet using the security association, the classification processor includes a classification matching engine that is indexed based on the one or more characteristics of the data packet and outputs the security association and decryption information that is used to decrypt the payload of the data packet, and the destination includes one or more packet processing elements being executed by one or more host processors, the one or more packet processing elements being configured to perform packet processing operations on an unencrypted payload of the data packet.

In some aspects, the techniques described herein relate to a method, wherein: the one or more characteristics of the data packet a 5-tuple of the data packet and a security parameter index (SPI), and the matching engine includes a content addressable memory (CAM) that, in response to the one or more characteristics of the data packet matching a CAM entry, output a CAM entry rule causing the classification processor to determine the cryptograph information that is encoded in the header of the data packet.

In some aspects, the techniques described herein relate to a method, wherein: the data packet is part of outbound traffic, the cryptography operation includes encrypting a payload of the data packet using the security association, the classification processor includes a one or more packet processing elements being executed by one or more host processors, the one or more packet processing elements encoding the cryptograph information in the header of the data packet, and the destination is a network node indicated by a destination address in the header of the data packet.

In some aspects, the techniques described herein relate to a method, wherein: the data packet includes an Ethernet frame encapsulating a payload including an Internet protocol (IP) packet, and the security association includes information of an IP security (IPSec) tunnel.

In some aspects, the techniques described herein relate to a method, wherein: the data packet is part of inbound traffic, the cryptography operation includes decrypting a payload of the data packet using the security association, and the method further includes: determining, at a routing device, that the data packet is not qualified for decrypting the payload using an express path, transmitting, from the routing device to one or more packet processing elements running on one or more host processors, the data packet, the one or more packet processing elements including the classification processor, and performing, by the cryptography processor, the decrypting of the payload to provide the data packet with an unencrypted payload, and removing the cryptograph information from the header of the data packet with the unencrypted payload before transmitting the data packet to the destination, wherein the destination is the one or more packet processing elements running on the one or more host processors.

In some aspects, the techniques described herein relate to a computing system including: one or more processors; and a memory storing instructions that, when executed by the one or more processors, configure the computing system to: classify, at a classification processor, a security association of a data packet based on one or more characteristics of the data packet; encode, in a header of the data packet, cryptograph information representing the security association; send, to a crypto device from the classification processor, the data packet together with the cryptograph information in the header of the data packet; perform, by a cryptography processor of the crypto device, a cryptography operation on the data packet based on the cryptograph information in the header of the data packet; and remove the cryptograph information from the header of the data packet before transmit the data packet to a destination of the data packet.

In some aspects, the techniques described herein relate to a non-transitory computer-readable storage medium, the computer-readable storage medium including instructions that when executed by a computer, cause the computer to: classify, at a classification processor, a security association of a data packet based on one or more characteristics of the data packet; encode, in a header of the data packet, cryptograph information representing the security association; send, to a crypto device from the classification processor, the data packet together with the cryptograph information in the header of the data packet; perform, by a cryptography processor of the crypto device, a cryptography operation on the data packet based on the cryptograph information in the header of the data packet; and remove the cryptograph information from the header of the data packet before transmit the data packet to a destination of the data packet.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for a hybrid platform that uses a combination of hardware and software solutions for securely processing data packets at high data rates. As discussed above. Software defined wide area network (SDWAN) technologies continue to evolve and operate at ever-increasing data rates. For example, emerging technology for SDWAN can result in functions operating at more than 50-Gbps to perform IQDF for next-generation platforms.

Scaling current network solutions to higher data rates can present various challenges. To overcome these challenges, a next-generation, high-end SDWAN platform can use a hybrid model that combines specialized hardware (e.g., cryptography accelerators) and general-purpose x86 CPUs in a single system to achieve performance up to 400-Gbps for SDWAN applications with Internet Mix (IMIX) packets. To reach these higher data rates, most non-stateful features such as crypto function can be offloaded from a CPU running Service Packet Processor (SPP) software to be performed using stand-alone crypto device and other specialized hardware components.

Such a hybrid platform can presents unique challenges. For example, the stand-alone crypto device may support fewer security associations (SAs) than the number of IPSec tunnels that require support. Consider the illustrative example of a crypto device that does not support a high IPSec tunnel scale, whereas the SDWAN deployment scenario can require more than 640K SAs. In this illustrative example, the hybrid platform faces the challenge of supporting IPSec classification at this level of SA scale (e.g., more than 640K SAs) and natively mapping the SAs to hardware.

Another challenge of the hybrid platform is reducing the number of times a packet transits the CPU. For example, a packet dataflow in which a packet transits the CPU only once has a system-level performance advantage over an alternative data flow in which the packet transits the CPU multiple times.

The systems and methods disclosed herein address the above-noted challenges. The hybrid platform disclosed herein can advantageously provide: (1) outbound IPsec packet processing; (2) inbound IPsec packet processing; (3) fallback inbound IPSec packet processing, and (4) outbound IPSec packet processing error handling.

According to certain non-limiting examples, the systems and methods disclosed herein can provide IPSec processing using a hybrid platform that combines software and hardware components. To support more IPSec tunnels, a customized header can be used to encode SAs and other cryptography-related information. The customized header allows the SAs to be determined by another component (e.g., a switch) rather than the crypto device, and this other component can be selected based on its capacity to support more IPSec tunnels than can typically be supported by a crypto device. Then, after the other component has determined the SAs (and other cryptography-related information), the SAs can be encoded in the customized header. Upon receiving the data packet with the customized header, the crypto device retrieves the SAs from the customized header and uses the SAs for cryptography processing. That is, the customized header allows the function of determining the SAs to be performed separately (e.g., on a separate device) from the cryptography operations.

In the dataflow, the SAs are determined before the cryptography operations so that they can be used for the cryptography operations. Accordingly, for inbound traffic, the SAs can be determined in a packet classifier and traffic manager module (CTM) implemented in a routing device (e.g., a top-of-rack switch) through which the packets pass before the crypto device. Similarly, for outbound traffic, the SAs can be determined by packet processing element (PPE) software running in the host CPU, which is before the crypto device. These examples are referred to as the express path because they enable more efficient packet processing. For example, the efficiency of packet processing is improved by minimizing the number of times the packets are transmitted between the host processor and the crypto device.

According to certain non-limiting examples, a fallback data path can be used for inbound traffic that is determined by the CTM to not qualify for the express path. In this case, the PPE software running in the host CPU classifies the packet and determines the SAs. The customized header is still used to encode SA for the packet, but the PPE—not the CTM in the routing device—encodes the SA in the customized header. The PPE sends the packet with the customized header to the crypto device, and the PPE receives the packet with an unencrypted payload after it has been processed by the crypto device.

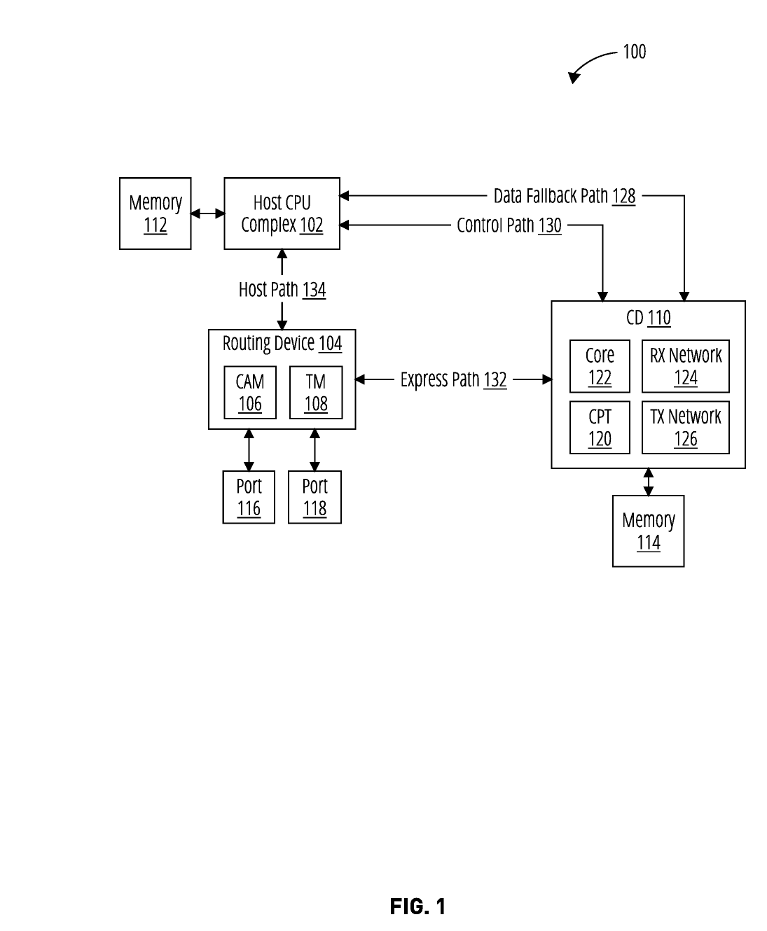

FIG. 1 illustrates, hybrid platform 100 for more efficiently processing network data. The hybrid platform 100 comprises host CPU complex 102, Routing device 104, a cryptography device (e.g., CD 110), a memory 112, a memory 114, a receiver (RX) network port (e.g., port 116), a transmitter (TX) network port (e.g., port 118), and CPU core 122.

Routing device 104 can be a switch, a top-of-shelf (TOS) switch, a router, or another device that can direct network traffic. According to certain non-limiting examples, routing device 104 can include a Content Addressable Memory (e.g., CAM 106) and a traffic manager (e.g., TM 108). CD 110 can include CPT 120, CPU core 122, RX network 124, and TX network 126.

Hybrid platform 100 includes express path 132 connecting routing device 104 to CD 110. Express path 132 enables more efficient processing of inbound and outbound data packets/frames by enabling various security operations, such as encryption and encryption, to be offloaded from host CPU complex 102 to CD 110. For example, all security information (e.g., encryption-related information or decryption-related information) can be encoded in a header such that, host CPU complex 102 need only be relied on for other aspects of the packet processing and not for the cryptographic processing.

Some packets may not be able to be processed using express path 132. In this case, data fallback path 128 can be used for crypto-related communications between host CPU complex 102 and CD 110, as discussed below. According to certain non-limiting examples, data fallback path 128 can be used for Internet protocol (IP) security (IPSec) decryption and sym-key operations in which a symmetric key (sym key) is used to encrypt and decrypt data.

Further, control path 130 allows control communications between host CPU complex 102 and CD 110, as discussed below. Control path 130 can be used to enable communications between host CPU complex 102 and CD 110. Further, control path 130 can be used to initialize the crypto-device, for example, by setting up the crypto module (CPT) and security association (SA) related values such as the hardware SA contact index, etc. Memory 114 can be used to store these cryptography values and used as a packet buffer. Similarly, memory 112 can also function as a packet buffer and store SA-related values such as the hardware SA index, crypto device software SA, Further, control path 130 can be used for other communications between host CPU complex 102 and CD 110, which can include, but are not limited to, sending CD notifications, pulling packet statistics, and sending modular exponentiation requests.

Host path 134 is used to send and receive data frames/packets between host CPU complex 102 and routing device 104. According to certain non-limiting examples, data fallback path 128, control path 130, and host path 134 can include, but is not limited to, a Peripheral Component Interconnect Express (PCIe) bus. However, other types of communications protocols, ports and buses can be used among the components of hybrid platform 100, as would be understood by a person of ordinary skill in the art. Further, the respective communication paths can use different communication protocols, as would be understood by a person of ordinary skill in the art.

According to certain non-limiting examples, hybrid platform 100 can provide packet processing for a software defined wide area network (SDWAN). The hybrid design of hybrid platform 100 can provide improved efficiency and higher bandwidths by offloading cryptography operations from host CPU complex 102 to CD 110. This can be especially important for IPSec data flows at data rates greater than 50-Gbps (gigabits per second).

As discussed above, compared to software-only solutions, the hybrid platform 100 disclosed herein has advantages, especially at high data rates. For low data rates, a software-only solution can be used by programming one or more processors (e.g., host CPU complex 102) to perform both cryptography operations and other packet processing operations. The software-only solution has the advantage of being flexible such that evolving stateful features used in enterprise SDWAN offerings can be implemented simply by updating the software.

Existing processors are not sufficiently fast to implement the software-only solution at higher data rates (e.g., greater than 50-Gbps). Hardware-only solutions can be implemented at these higher data rates. However, hardware-only solutions lack the flexibility to implement evolving stateful features used in enterprise SDWAN offerings. Hybrid platform 100 combines the benefits of the hardware-only solution with the benefits of the software-only solution. The flexibility to implement evolving stateful features can be realized by updating the software running in host CPU complex 102, and higher data rates can be realized by offloading computationally intensive cryptography operations to the specialized hardware and accelerators in CD 110.

According to certain non-limiting examples, host CPU complex 102 executes control plane (CP) software that manages the control path of the whole system and executes packet processing elements (PPE) software that handles generic data path processing. Achieving 50-Gbps performance for SDWAN intelligent queue definition function (IQDF) can be realized, e.g., by using multiple CPU cores in host CPU complex 102.

According to certain non-limiting examples, the crypto device (e.g., CD 110 ) includes a crypto module (e.g., CPT 120) that implements protocol processing, IPSec operation, and/or various other crypto-related hardware acceleration functions. Thus, computing-intensive functions can be offloaded from host CPU complex 102 CD 110 and CPT 120.

According to certain non-limiting examples, routing device 104 can include a packet classifier and traffic manager module (CTM), which is a combination of CAM 106 and TM 108. The CTM implements two major functions: 1) a packet classifier that classifies the packets received from CPU port, network ports, or crypto device to determine the appropriate action and 2) a traffic manager (TM) that schedules the packet based on the packet header information and classification results.

According to certain non-limiting examples, to support SDWAN generic data processing, various stateful features can be used, and these stateful features can be processed by host CPU complex 102. The above-discussed configuration can reduce the number of times a given packet enters and leaves host CPU complex 102, thereby improving the efficiency of packet processing. For example, many data packets can follow an express packet flow in which the packet only leaves (outbound packet) or enters (inbound packet) host CPU complex 102 once.

According to certain non-limiting examples, the systems and methods disclosed herein use CAM 106 to perform inbound security association (SA) lookup. For example, CAM 106 can be a classification module that is separate from CD 110. In contrast to the systems and methods disclosed herein, an inline IPsec hardware implementation uses IPSec security parameter index (SPI) of the IPsec packet as an index to an SA table to determine the SA for inbound traffic. A challenge of the inline IPsec hardware implementation (which is overcome by the systems and methods disclosed herein) is that using the SPI alone is generally insufficient to differentiate IPsec tunnels. Further, even for applications that can use the SPI to uniquely identify IPsec tunnels (e.g., IKEv1 and IKEv2), the inline IPsec hardware implementation is nevertheless not feasible for direct indexing because the SPI is a random value that is 32 bits long (i.e., 2³²=4Gbits), making it too large for direct indexing.

To avoid the above-noted challenges of the inline IPsec hardware implementation, the systems and methods disclosed herein can use a match content addressable memory (MCAM) memory (e.g., CAM 106) to implement an inbound SA lookup table. The MCAM memory is a hardware resource that receives as an input a search query and returns as the output the information retrieved from the address matching the search query. According to certain non-limiting examples, the MCAM can be a lookup table that uses a combination of the IP 5-tuple and the SPI as the lookup key. The number of IPsec tunnels supported can be dictated by the size of the MCAM. When the number of IPSec tunnels exceeds the MCAM size, additional IPSec tunnels that are not indexed in the MCAM can be handled using a software lookup table. For IPSec tunnels that are indexed in the MCAM, performance is improved because traffic corresponding to these IPSec tunnels can be handled using the express path. For IPSec tunnels that are not indexed in the MCAM, the use of the software lookup table increases the software burden and reduces the overall system efficiency. According to certain non-limiting examples, the number of IPSec tunnels not indexed in the MCAM can be either zero or much smaller than the number of IPSec tunnels indexed in the MCAM. Further, the IPSec tunnels that are not indexed in the MCAM can be selected to be IPSec tunnels having less traffic volume than the IPSec tunnels that are indexed in the MCAM.

According to certain non-limiting examples, the systems and methods disclosed herein use a packet classifier module (e.g., CAM 106) to classify data packets and generate IPSec tunnel classification results, which are then forwarded together with the data packet to a crypto device (e.g., CD 110). The packet classifier module and the crypto device can be implemented in the same physical device. Alternatively, implementing the packet classifier module and crypto device in separate devices can be preferable in order to use larger CAM table. For example, a routing/switching application specific integrated circuit (ASIC) may be able to implement a larger CAM table than can be implemented on the hardware implementing the crypto device. Accordingly, routing device 104 can be a routing/switching ASIC that is implemented in separate hardware from CD 110, and CD 110 can be implemented using a hardware accelerator optimized for cryptography operations.

According to certain non-limiting examples, the IPSec tunnel classification results can be cryptography-related information encoded in a customized header of the data packet (e.g., an ethernet frame having a payload that includes an IP packet). The customized header can be referred to as a crypto device data input request header, and it can provide a communication mechanism used by the packet classifier module to deliver various cryptography-related information (e.g., an SA index) to the crypto device.

A CAM can be used to provide high-speed, real-time indexed matching. By allowing data to be retrieved based on its content, CAM eliminates the need for traditional address-based lookup, providing performance benefits in applications where speed and real-time information retrieval are used, such as networking and routing. CAM can be used as an indexed matching engine because of its ability to perform fast, parallel lookups to find a match to a given key or search value. This makes it useful for applications that depend on high-speed, real-time matching, such as networking. According to certain non-limiting examples, when the search key is sent to the CAM, the CAM compares the key to all stored values in parallel. If a match is found, the CAM returns the index (position) where the data resides, which could be used for further processing. In the absence of a match, the system can return an indication of no match.

According to certain non-limiting examples, the host CPU complex performs, for outbound traffic, a similar function to the function of CAM 106 for inbound traffic. That is, for outbound traffic, the host CPU complex improves efficiency by preparing the customized header that is then used by the crypto device to encrypt the IP packet. The information provided in the customized header enables the crypto device to perform all cryptography operations on the packet without further communications with the host CPU complex. Without this mechanism, the packet processing efficiency is degraded because packets will traverse the CPU complex at least two times. All packets qualified for the express data flow can achieve the maximum crypto performance as the host CPU spends minimum cycles on the packet processing. When the packets are not qualified for express path, such as fragment packets, the CPU complex PPE software pre-processes the packets before sending them to CD 110 via the data fallback path 128. Once processed, these not qualified packets return to host CPU complex 102 via data fallback path 128.

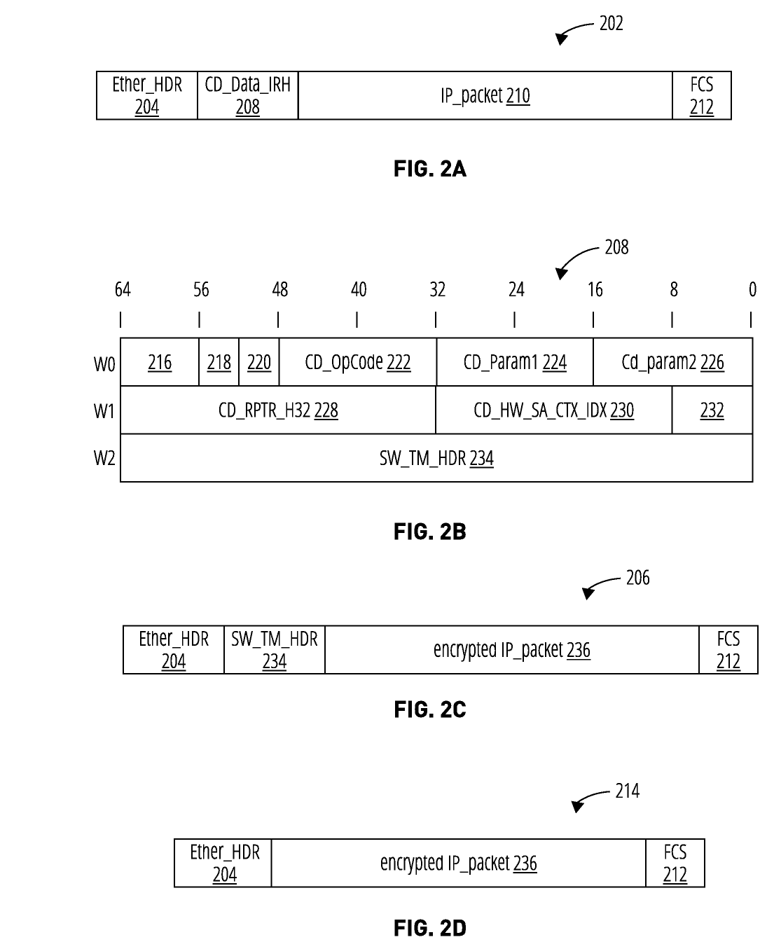

FIG. 2A illustrates Ethernet frame 202, which includes an Ethernet header (e.g., Ether_HDR 204), a crypto device data input request header (e.g., CD_Data_IRH 208), a payload (e.g., IP_packet 210), and a frame check sum (e.g., FCS 212). Ethernet frame 202 is a non-limiting example of an Ethernet frame for outbound traffic generated by a PPE running on host CPU complex 102. CD_Data_IRH 208 includes encryption-related information that is used for the express path through CD 110.

For outbound traffic, Ethernet frame 202 represents the Ethernet frame sent from host CPU complex 102 to routing device 104 via host path 134. Ethernet frame 206 (shown in FIG. 2C) represents the Ethernet frame sent from CD 110 to routing device 104 via express path 132, after CD 110 has processed/encrypted the IP_packet to generate encrypted IP_packet 236. Ethernet frame 214 represents the Ethernet frame that is transmitted from routing device 104 to its destination address (e.g., via an IPSec tunnel).

As discussed below, CD_Data_IRH 208 can be used for express path IPsec encryption. For example, a PPE running on host CPU complex 102 can prepare an outbound IPsec packet inside an Ethernet frame and send the frame to a switch (e.g., routing device 104). The Ethernet frame can include an EtherType field that indicates the Ethernet frame is to undergo express path IPsec encryption. According to certain non-limiting examples, the indication that the frame is to undergo express path IPsec encryption is signaled by the EtherType of the frame having a value of 0x9990. Upon receiving the Ethernet frame along host path 134 from host CPU complex 102, routing device 104 can determine that EtherType of the frame has a value of 0x9990, and routing device 104 can direct the frame along express path 132 to CD 110 for express path IPsec encryption. For example, when the frame hits a CPU port of routing device 104, routing device 104 determines the CAM entry corresponding to the EtherType of the frame. Then, the matched CAM entry rule directs the frame to the specified encryption process for the frame.

CD_DATA_IRH 208 is the "Crypto Device data Input Request Header" for Express Path IPsec Encryption and can be referred to by the abbreviation IRH. The IRH can begin with an 8-bit match pattern CD_Data_IRH_Exp_IPSec_Enc 216. A specified value for CD_Data_IRH_Exp_IPSec_Enc 216 (e.g., 0xC0) can signal that the Ethernet frame is to be processed using express path IPsec encryption. The IRH format is illustrated in FIG. 2B and discussed below.

The Ethernet frame structure can depend on various aspects and protocols of the frame. For an Ethernet frame used in an IPsec tunnel, the payload of the Ethernet frame can be an encapsulated and encrypted packet. The Ethernet frame can include an ESP (Encapsulating Security Payload) header and other IPsec-specific fields. The Ethernet frame carries the IPsec-protected traffic as its payload.

The Ethernet Frame Header can include several fields. A preamble field can prepare the receiver to properly interpret the incoming frame (e.g., used for synchronization for the receiver). The Start Frame Delimiter (SFD) field marks the start of the frame. The Destination MAC Address is the MAC address of the receiving network interface. The Source MAC Address is the MAC address of the sending network interface. The EtherType field in the Ethernet Frame Header can indicate the type of protocol encapsulated in the payload (e.g., for IP packets, a value of 0x0800 can indicate IPv4 or a value of 0x86DD can indicate IPv6).

The payload is the actual data being transmitted, and, after encryption has been performed, the payload contains the IPsec-protected packet.

In IPsec Tunnel Mode, the entire original IP packet (including the IP header) is encapsulated within a new IP header, which is then placed in the payload of the Ethernet frame. For example, a secure tunnel can be created between two networks (e.g., between a VPN gateway and a remote device). The Encapsulating Security Payload (ESP) can be used to encrypt and/or authenticate the data being transmitted and is part of the IPsec suite and can provide confidentiality (encryption), integrity (authentication), and optional replay protection. In an IPsec frame, ESP headers are inserted as part of the IP packet. These headers are used to protect the payload of the original packet (which could be any higher-layer protocol, like TCP or UDP). ESP is used for both encryption and authentication in the IPsec tunnel.

The ESP Header can include various field. The Security Parameter Index (SPI) field provides a unique identifier for the security association. The SPI is used to distinguish between multiple security associations (SAs) at the receiving end and helps the receiver know which decryption/authentication key to use. The Sequence Number field provides a unique number assigned to each packet within a security association (SA). This helps with anti-replay protection (prevents replay attacks). The ESP Header field contains flags and the next header type, which indicates the type of the next layer protocol (e.g., TCP, UDP). The Payload Data field provides the encrypted data representing the original IP packet's payload. Padding can be used to ensure that the total length of the encrypted data is a multiple of the encryption block size (e.g., 8 bytes for DES or 16 bytes for AES). The Pad Length indicates how much padding was added to the payload. A Next Header field can be used to identify the protocol type of the encapsulated data (e.g., TCP, UDP).

After the ESP header, the encrypted data is stored. An ESP trailer can contain additional padding and authentication data (optional if integrity protection is enabled). An Authentication Data field can provide integrity protection, and this field can hold an authentication tag. A Frame Check Sequence/Sum (FCS) field can contain, for example, a Cyclic Redundancy Check (CRC) checksum (e.g., CRC-32 checksum) of the Ethernet frame's contents (including the Ethernet header and the payload, which includes the IPsec-protected data). The FCS can be used to detect transmission errors.

FIG. 2B illustrates a non-limiting example of CD_Data_IRH 208. CD_Data_IRH 208 includes the following fields: a crypto device data input request header (e.g., CD_Data_IRH_Exp_IPSec_Enc 216), a Sequence Number Space (SNS) Index (e.g., SNS_IDX 218), a reserved field (e.g., reserved 220), crypto device operation code (e.g., CD_OpCode 222), crypto device parameter one (e.g., CD_Param1 224), crypto device parameter two (e.g., CD_Param2 226), a crypto device parameter three (e.g., CD_RPTR_H32 228), a crypto device hardware security association contact index (e.g., CD_HW_SA_CTX_IDX 230), an offset from CD_Data_IRH 208 to the data/payload (e.g., CD_DPtr_Offset 232), and a switch traffic management header (e.g., SW_TM_HDR 234).

For example, SNS_IDX 218 can be used to determine the order in which the packets are queued. The order in which packets are queued can depend, among other things, on the quality of service (QoS) class and/or the traffic class of the packets. and other factors. For example, to support multiple sequence number spaces on the same tunnel, one sequence number can be assigned per traffic class, and SNS_IDX 218 can be used to determine the order in which the packets are queued. According to certain non-limiting examples, the value of SNS_IDX 218 that is used for a particular class of packets ensures that the packets for the same type of class will be assigned to the same sequence number space, resulting in these packets going to the same queue. Accordingly, the order of the queue can be the order of the packets, ensuring that the packets are not out of order.

When an IPSec session is created, a contact is identified inside the cryptography hardware to perform the cryptography operations, and this contact is identified inside the cryptography hardware is identified by CD_HW_SA_CTX_IDX 230.

To perform cryptography operations, CD 110 can use various parameters (i.e., CD_Param1 224, CD_Param2 226, and CD_RPTR_H32 228.

CD_DPtr_Offset 232 is used to determine at which bit location the data starts.

SW_TM_HDR 234 is not used by CD 110. Rather, SW_TM_HDR 234 is used by routing device 104 after the packet has been processed by CD 110. For example, SW_TM_HDR 234 can be used by routing device 104 for traffic management. That is, SW_TM_HDR 234 can direct the switch (e.g., routing device 104) on how to perform traffic management, including, for example, directing the queuing mechanism and other details that are relevant to the switch but not to the cryptography hardware (e.g. CD 110).

FIG. 2C illustrates the outbound Ethernet frame after it has been processed by CD 110 using the express path. As discussed above, Ethernet frame 206 represents the Ethernet frame sent from CD 110 to routing device 104 via express path 132, after CD 110 has processed/encrypted the IP_packet to generate encrypted IP_packet 236. Ethernet frame 206 includes Ether_HDR 204, SW_TM_HDR 234, encrypted IP_packet 236, an FCS 212. As discussed above, SW_TM_HDR 234 is used by routing device 104 after the packet has been processed by CD 110. For example, SW_TM_HDR 234 can be used by routing device 104 to perform traffic management. Except for SW_TM_HDR 234, the other fields of CD_Data_IRH 208 are used by CD 110 to perform encryption/security processing. Therefore, those other fields of CD_Data_IRH 208 are not needed after the encryption/security processing by CD 110 is complete, allowing those other fields to be removed before returning the Ethernet frame to routing device 104. On the other hand, SW_TM_HDR 234 is used by routing device 104 for traffic management, and therefore SW_TM_HDR 234 is not removed before returning the Ethernet frame to routing device 104.

FIG. 2D illustrates the outbound Ethernet frame after it has been prepared for transmission to its destination. Ethernet frame 214 includes Ether_HDR 204, IP_packet 210, and FCS 212. As discussed above, Ethernet frame 214 represents the Ethernet frame that is transmitted from routing device 104 to its destination address (e.g., via an IPSec tunnel). SW_TM_HDR 234 is removed from Ethernet frame 214 because it has already been used for its purpose and it no longer needed.

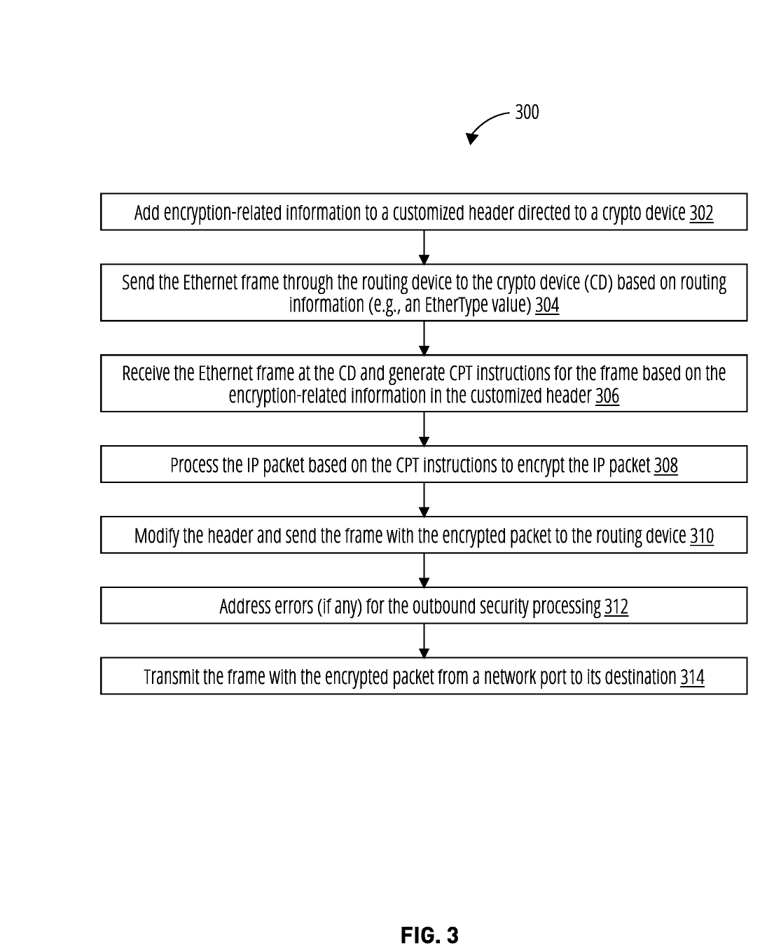

FIG. 3 illustrates an example method 300 for processing outbound traffic through hybrid platform 100 using the express path (e.g., express paths 132). Although the example method 300 depicts a particular sequence of operations, the sequence may be altered without departing from the scope of the present disclosure. For example, some of the operations depicted may be performed in parallel or in a different sequence that does not materially affect the function of method 300. In other examples, different components of an example device or system that implements method 300 may perform functions at substantially the same time or in a specific sequence.

According to some examples, block 302 of the method includes adding encryption-related information to new field in a header of an ethernet frame. For example, a PPE running on host CPU complex 102 illustrated in FIG. 1 may add encryption-related information in CD_Data_IRH 208 of Ethernet frame 202.

According to certain non-limiting examples, Packet Processing Element (PPE) software running in host CPU complex 102 prepares outbound IPsec packet (e.g., IP_packet 210) inside an Ethernet frame (e.g., Ethernet frame 202) and sends the frame to the packet Classifier/Traffic Manager (CTM) module (e.g., the combination of CAM 106 and TM 108 in routing device 104). The frame can contain a special EtherType value that is followed by the Crypto Device data Input Request Header (e.g., CD_DATA_IRH 208). The special EtherType value can be used to indicate that the packet is to be processed using the express path IPsec encryption. Further, CD_DATA_IRH 208 can contain encryption-related information, including, for example, a security association (SA) index, one or more pointers (e.g., CD_DPtr_Offset 232), and CD_DATA_IRH 208 can contain, traffic manager (TM) related information such as a queue identifier (ID) and SW_TM_HDR 234.

According to some examples, block 304 of the method includes sending the ethernet frame through the routing device to the crypto device (CD). Further, the ethernet frame can be sent/routed from host CPU complex 102 through routing device 104 to CD 110 based on a value of the EtherType field in Ethernet frame 202.

According to certain non-limiting examples, the routing device 104 illustrated in FIG. 1 may route Ethernet frame 202 from host CPU complex 102 to CD 110 based on the EtherType value being 0x9990. For example, the packet Classifier/Traffic Manager module (CTM) receives the Ethernet frame having a special Ethertype value associated CD_DATA_IRH header. The frame hits CTM’s CPU port CAM entry for the CD_DATA_IRH EtherType. Then, the matched CAM entry rule directs the frame to the Crypto Device (CD) via the encryption port of the express crypto data path between routing device 104 and CD 110.

According to some examples, block 306 of the method includes receiving the ethernet frame at the CD and generating CPT instructions for the frame based on the encryption-related information in the customized header (e.g., CD_Data_IRH 208). For example, CD 110 illustrated in FIG. 1 may receive Ethernet frame 202 and generate CPT instructions for the frame based on the encryption-related information (e.g., CD_Data_IRH_Exp_IPSec_Enc 216, CD_HW_SA_CTX_IDX 230, etc.) in CD_Data_IRH 208.

According to certain non-limiting examples, the crypto device (CD) can receive the Ethernet frame from the encryption port of CD 110. The frame hits an encryption port CAM entry for the EtherType. The matched CAM entry rule directs CD 110 to execute CD-network-reception logic for retrieving the SA index, pointers, and other encryption-related parameters from CD_DATA_IRH 208 header. Then, the CD-network-reception logic is used to construct the crypto instruction using the retrieved information and sends the instruction to a CPT Inline Encryption local function (LF).

According to some examples, block 308 of the method includes processing the IP packet based on the CPT instructions to encrypt the IP packet. For example, CPT 120 illustrated in FIG. 1 may process the IP packet based on the CPT instructions to encrypt the IP packet.

According to certain non-limiting examples, based on the received CPT instructions, CPT 120 performs in-place IPsec outbound packet processing on the data in the buffer pointed to by the pointer parameters of CPT instruction (e.g., the beginning of the data packet indicated by CD_DPtr_Offset 232). After processing the packet, CPT 120 sends the processed packet to CPU core 122 to CD’s CPU core.

According to some examples, block 310 of the method includes modifying the header and sending the frame with the encrypted packet to the routing device. For example, the CPU core 122 of CD 110 illustrated in FIG. 1 may modify the header and send the frame with the encrypted packet to routing device 104.

According to certain non-limiting examples, the CPU core of the crypto device (CD) removes the encryption-related information from CD_DATA_IRH 208 of the encrypted IPsec packet, only keeping the traffic manager portion (e.g., SW_TM_HDR 234) to generate Ethernet frame 206. CD 110 then sends Ethernet frame 206 back to routing device 104 via the encryption port corresponding to express path 132.

According to some examples, block 312 of the method includes addressing errors (if any) for the outbound security processing. For example, the routing device 104 illustrated in FIG. 1 may address errors for the outbound security processing.

According to certain non-limiting examples, when outbound IPSec processing encounters any error such as soft or hard lifetime expiration, CD 110 can send a special error notification packet that includes the SA index and error type information to host CPU complex 102. Host CPU complex 102 can then take appropriate action. For example, in the case in which the hard lifetime expires, host CPU complex 102 can disable the corresponding tunnel.

According to some examples, block 314 of the method includes transmitting the frame with the encrypted packet from a network port to its destination. For example, the routing device 104 illustrated in FIG. 1 may transmit the frame with the encrypted packet from a network port to its destination.

According to certain non-limiting examples, routing device 104 can receive the Ethernet frame on its encryption port, and routing device 104 determines an encryption port CAM entry that matches the CD_DATA_IRH EtherType. The matched CAM entry rule can then direct routing device 104 to use the traffic manager information such as queue ID from SW_TM_HDR 234 of CD_DATA_IRH 208. Based on this queue ID, routing device 104 can enqueue the frame to the correct TM queue for TM 108 to schedule the frame for transmission (TX) from the TX network port (e.g., port 118).

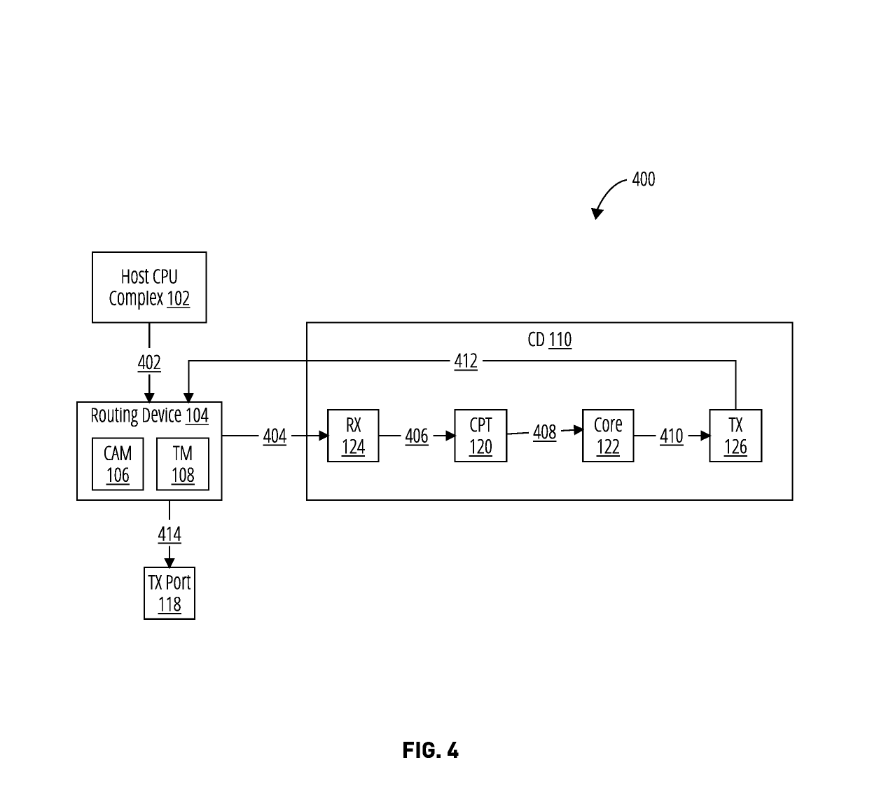

FIG. 4 illustrates an example of express outbound flow 400. This flow includes steps 402-414.

In step 402, PPE software running on host CPU complex 102 prepares an outbound IPsec packet inside an Ethernet frame and sends the frame to routing device 104. The EtherType of the frame can be 0x9990, indicating that the frame is to be processed using express path IPsec encryption. The frame can have the format shown in FIG. 2A.

Express outbound flow 400 comprises a host CPU complex 102, a routing device 104, a CAM 106, a TM 108, a CD 110, a port 118, a CPT 120, a CPU core 122, an RX network 124, a TX network 126, a step 402, a

In step 404, routing device 104 receives the Ethernet frame with the EtherType 0x9990 from a CPU port. The frame matches a CAM entry corresponding to the EtherType value, and the rule for the matched CAM entry directs the frame to RX network 124 via an encryption port between routing device 104 and RX network 124

In step 406, RX network 124 receives the Ethernet frame from the encryption port. The frame matches with an encryption port MCAM entry for the EtherType value of the frame. The matched MCAM entry rule directs RX network 124 to retrieve various values from the field of CD_Data_IRH 208, including, for example, CD_OpCode 222, CD_Param1 224, CD_Param2 226, CD_HW_SA_CTX_IDX 230, SNS_IDX 218, CD_RPTR_H32 228, and CD_DPtr_Offset 232. RX network 124 can construct the CPT instruction using the retrieved values and sends the CPT instruction to the inline encryption local function (LF) of CPT 120.

In step 408, CPT 120 receives the CPT instruction and performs in-place IPsec outbound packet processing on the data in the buffer pointed by the CD_DPtr_Offset 232. Then, CPT 120 sends the processed frame to CPU core 122.

In step 410, CPU core 122 clips the W0 and W1 from the CD_DATA_IRH 208 in FIG. 2B, only keeping the SW_TM_HDR 234. Further, CPU core 122 can rewrite EtherType to a value indicating SW_TM_HDR 234 follows Ether_HDR 204, and then sends the modified Ethernet frame to routing device 104 via the encryption port of TX network 126. The modified frame has the format of Ethernet frame 206 illustrated in FIG. 2C.

In step 412, routing device 104 receives the Ethernet frame 206 on an encryption port of routing device 104 and determines a CAM entry that matches the EtherType indicating SW_TM_HDR 234 follows Ether_HDR 204. The rule for the matched CAM entry directs routing device 104 to clip SW_TM_HDR 234 and to rewrite the EtherType value to generate Ethernet frame 214 illustrated in FIG. 2D. Next, routing device 104 enqueues the frame to a TM queue for TM 108 to schedule the transmission of Ethernet frame 214.

In step 414, routing device 104 transmits Ethernet frame 214 via port 118.

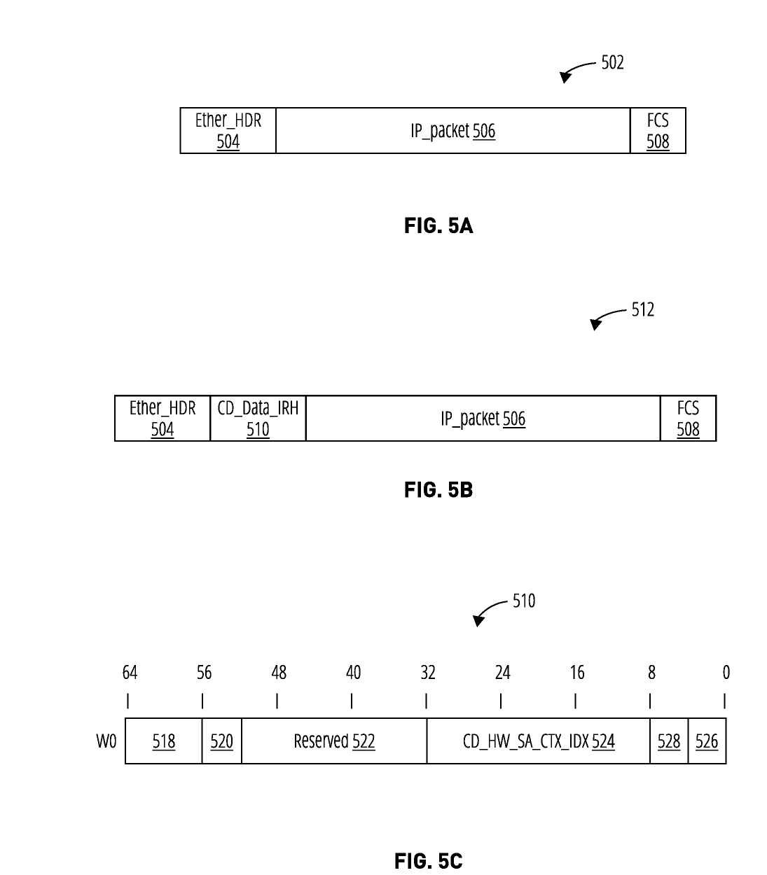

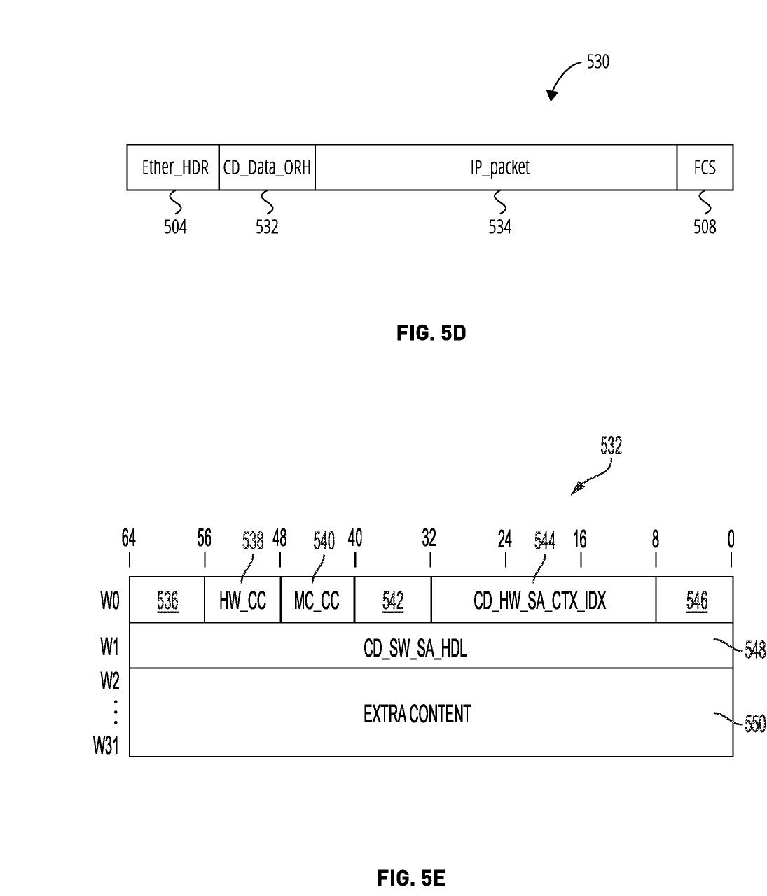

FIG. 5A illustrates Ethernet frame 502 for inbound traffic. Ethernet frame 502 includes an Ethernet header (e.g., Ether_HDR 504), a payload (e.g., IP_packet 506), and a frame check sum (e.g., FCS 508). For example, Ethernet frame 502 can represent an inbound Ethernet frame that is received from an IPSec tunnel at routing device 104.

For inbound traffic, Ethernet frame 502 represents the Ethernet frame received at routing device 104 from a network. Ethernet frame 512 represents the Ethernet frame sent from routing device 104 to CD 110 for decryption processing. Ethernet frame 530 represents the Ethernet frame sent from CD 110 to routing device 104 after decryption processing.

FIG. 5B illustrates Ethernet frame 512 for inbound traffic after CD_Data_IRH 510 has been added by routing device 104. For express path IPsec decryption, Ethernet frame 512 is sent to CD 110 via express paths 132.

FIG. 5C illustrates CD_Data_IRH 510. CD_DATA_IRH 510 is a Crypto Device data Input Request Header that includes a beginning match pattern (e.g., CD_Data_IRH_Exp_IPSec_Dec 518) indicating that the frame is to be processed using the express path IPsec decryption.

CD_Data_IRH 510 also includes an multiple sequence number space algorithm field (e.g., MSNS_Alg 520), a reserved field (e.g., reserved 522), a crypto device hardware security association contact index (e.g., CD_HW_SA_CTX_IDX 524), an Internet protocol (IP) offset field, (e.g., IP_Offset 528), and an encapsulating security payload (ESP) offset field (e.g., ESP_Offset 526).

FIG. 5D illustrates Ethernet frame 530 for inbound traffic after decryption processing when the Ethernet frame sent from CD 110 to routing device 104. Ethernet frame 530 is modified to include CD_Data_ORH 532. CD_Data_ORH 532 is a crypto device data output request header.

The system comprises an Ether_HDR 504, an FCS 508, an Ethernet frame 530, a CD_Data_ORH 532, and an IP_packet 534.

For inbound traffic, Ethernet frame 502 represents the Ethernet frame received at routing device 104 from a network. Ethernet frame 512 represents the Ethernet frame sent from routing device 104 to CD 110 for decryption processing. Ethernet frame 530 represents the Ethernet frame sent from CD 110 to routing device 104 after decryption processing.

FIG. 5E illustrates the various fields of CD_Data_ORH 532, according to certain non-limiting examples. CD_Data_ORH 532 includes a crypto device data output reques express path IPsec decryption result field (e.g., CD_DATA_ORH_EXP_IPSEC_DEC_RSLT 536), a hardware field completion code (e.g., HW_CC 538), a microcode completion code field (e.g., MC_CC 540), a reserved field (e.g., reserved 542), a crypto device hardware security association contact index field (e.g., CD_HW_SA_CTX_IDX 544), an extra words field (e.g., Extra_Words 546), a crypto device switch security association handle field (e.g., CD_SW_SA_HDL 548), an extra content field (e.g., Extra_Content 550).

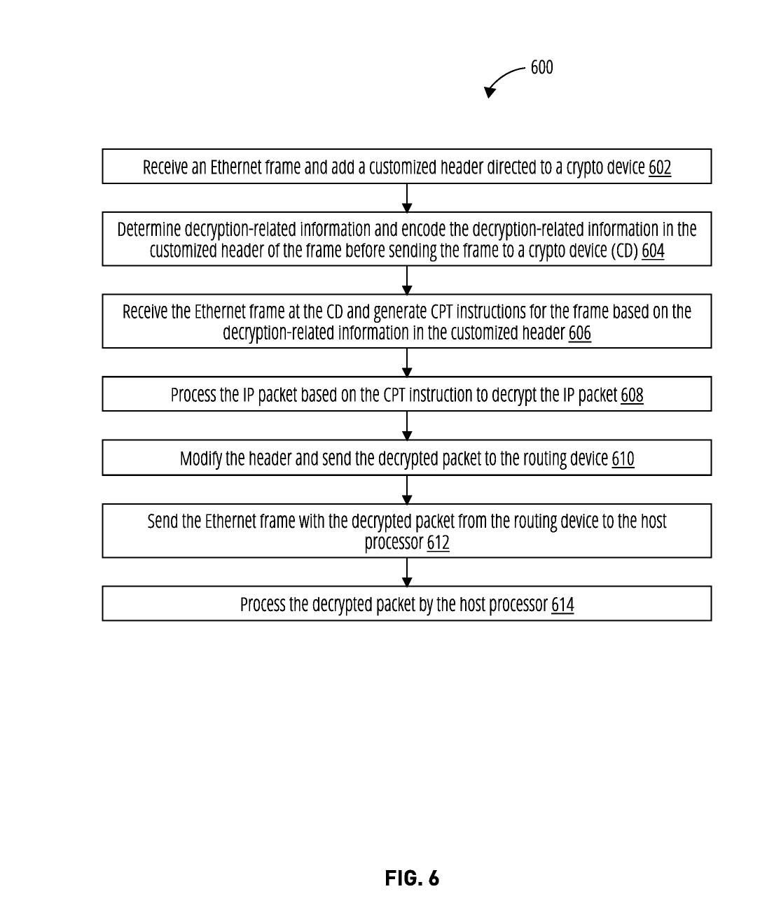

FIG. 6 illustrates an example method 600 for processing inbound traffic through hybrid platform 100 using the express path (e.g., express paths 132). Although the example depicts a particular sequence of operations, the sequence may be altered without departing from the scope of the present disclosure. For example, some of the operations depicted may be performed in parallel or in a different sequence that does not materially affect the function of method 600. In other examples, different components of an example device or system that implements method 600 may perform functions at substantially the same time or in a specific sequence.

According to some examples, block 602 of the method includes receiving, at a receiver network port (e.g., port 116), an Ethernet frame (e.g., Ethernet frame 502) having an encapsulated IP packet and adding a header (e.g., CD_Data_IRH 510) to the Ethernet frame, where the added header is used to convey data to a crypto device (e.g., CD 110). For example, routing device 104 illustrated in FIG. 1 may receive, at a network port, an ethernet framing having an encapsulated IP packet. A classification and traffic management module (CTM), which includes CAM 106 and TM 108 of routing device 104, receives an IP packet encapsulated in an Ethernet frame from an external network port.

According to some examples, block 604 of the method includes determining decryption-related information and encoding the decryption-related information in a customized header (e.g. CD_Data_IRH 510) of the frame before sending the frame to a crypto device (e.g., CD 110). For example, CAM 106 illustrated in FIG. 1 may determine decryption-related information and encode the decryption-related information in CD_Data_IRH 510 of Ethernet frame 512 before sending the frame to CD 110.

According to certain non-limiting examples, the CTM classifies the IP packet and matches an IPsec inbound CAM entry to determine the SA index information and an entry rule. The entry rule directs CTM to construct a CD_DATA_IRH header (e.g., CD_Data_IRH 510) that includes the SA index, IP offset, ESP offset, and other information. For example, CD_Data_IRH 510 can have the same fields as CD_Data_IRH 208. CD_DATA_IRH 510 can be a Crypto Device data Input Request Header that has a beginning match pattern (e.g., CD_DATA_IRH_EXP_IPSEC_DEC) indicating the packet is to be decrypted using express path IPsec decryption. Routing device 104 inserts CD_DATA_IRH 510 header after the Ethernet header and rewrites the EtherType value to indicate that the frame includes CD_DATA_IRH 510, generating Ethernet frame 512. Next, Ethernet frame 512 is sent to CD 110 via the decryption port between routing device 104 and CD 110.

According to some examples, block 606 of the method includes receiving the ethernet frame at the CD and generating CPT instructions for the frame based on the decryption-related information in the customized header. For example, CD 110 illustrated in FIG. 1 may receive the Ethernet frame 512 and generate the CPT instructions for the frame based on the decryption-related information in CD_Data_IRH 510.

According to certain non-limiting examples, CD 110 receives Ethernet frame 512 from the decryption port. The frame hits a decryption port CAM entry for the CD_DATA_IRH EtherType. The matched CAM entry rule directs CD-network-reception logic to retrieve from CD_DATA_IRH 510 various decryption-related information, including, for example, an SA index, IP offset, ESP offset, and other information. CD 110 can then construct CPT instruction using this retrieved information together with the CD's inline IPSec (inbound) configuration registers (e.g., operation code, parameters, etc.). CD 110 then sends the generated CPT instruction to an inline decryption local function (LF) of CPT 120.

According to some examples, block 608 of the method includes processing the IP packet based on the CPT instruction to decrypt the IP packet. For example, CPT 120 illustrated in FIG. 1 may process the IP packet based on the CPT instruction to decrypt the IP packet. For example, CPT 120 can receive the instruction and perform in-place IPsec inbound packet processing on the payload of Ethernet frame 512.

According to some examples, block 610 of the method includes modifying the header and sending the decrypted packet to routing device 104. For example, CPU core 122 illustrated in FIG. 1 may modify the header (e.g., replace CD_Data_IRH 510 with CD_Data_ORH 532) resulting in Ethernet frame 530 and sending Ethernet frame 530 to routing device 104.

According to certain non-limiting examples, CPU core 122 of CD 110 receives the decrypted IPsec packet and retrieves the CPT return code from the packet. Using the retrieved information, CPU core 122 constructs a Crypto Device data Output Request Header (e.g., CD_DATA_ORH 532), which can begin with an 8-bit match pattern (e.g., CD_DATA_ORH_EXP_IPSEC_DEC_RSLT) indicating that the frame is a result of express path IPsec decryption. Further, CPU core 122 can clip CD_Data_IRH 510 from the packet and replace it with CD_Data_ORH 532, which is inserted into the packet at the same location. CPU cores 122 then send the resulting Ethernet frame (e.g. Ethernet frame 530) back to routing device 104 via the decryption port.

According to some examples, block 612 of the method includes sending the Ethernet frame with the decrypted packet from the routing device to the host processor. For example, routing device 104 illustrated in FIG. 1 may send Ethernet frame 530 to host CPU complex 102. According to certain non-limiting examples, TM 108 receives the Ethernet frame and routes it to host CPU complex 102 from routing device 104.

According to some examples, block 614 of the method includes processing the decrypted packet by the host processor. For example, host CPU complex 102 illustrated in FIG. 1 may process the decrypted packet.

According to certain non-limiting examples, host CPU complex 102 receives the Ethernet frame 530 from routing device 104. For example, based on the EtherType value in CD_DATA_ORH 532, host CPU complex 102 can recognize the frame as an express path decrypted IPsec packet, and host CPU complex 102 forwards the packet to PPE software running on host CPU complex 102 for further processing.

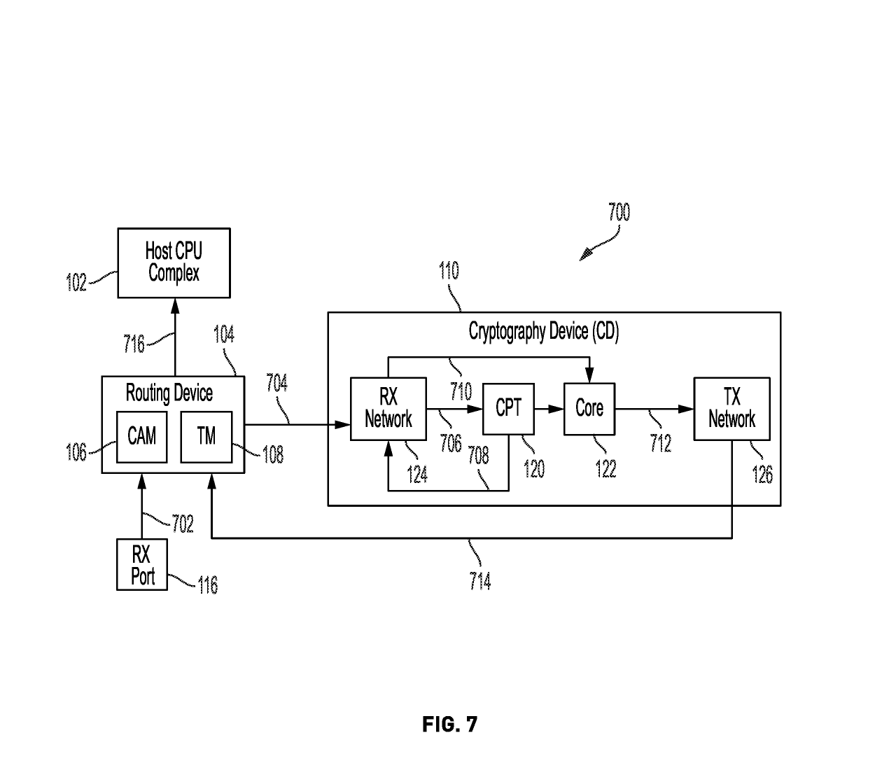

FIG. 7 illustrates an example of express inbound flow 700. This flow includes steps 702-716.

In step 702, routing device 104 receives, from an external RX port (e.g., port 116), and Ethernet frame 502 that encapsulates an IP packet.

The express inbound flow 700 comprises a host CPU complex 102, a routing device 104, a CAM 106, a TM 108, a CD 110, a port 116, a CPT 120, a CPU core 122, an RX network 124, a TX network 126, a step 702, .

In step 704, routing device 104 classifies the IP packet and matches an IPsec inbound global CAM entry, which provides the values for MSNS_Alg 520 and CD_HW_SA_CTX_IDX 524. The entry rule directs routing device 104 to construct CD_DATA_IRH 510 and to insert CD_Data_IRH 510 into Ethernet frame 512 after Ether_HDR 504. Further, routing device 104 rewrites EtherType to a value (e.g., 0x9991) indicating that the frame is to be processed using express path IPsec encryption. The resulting frame, Ethernet frame 512, is sent to RX network 124 via the decryption port between routing device 104 and RX network 124. CD_Data_IRH 510 is the Crypto Device data Input Request Header, which begins with an 8-bit match pattern CD_Data_IRH_Exp_IPSec_Dec 518. A specified value for CD_Data_IRH_Exp_IPSec_Dec 518 (e.g., 0xC1) can signal that the Ethernet frame is to be processed using express path IPsec decryption.

In step 706, RX network 124 receives Ethernet frame 512 from the decryption port. The frame hits a decryption port MCAM entry for the EtherType (e.g., 0x9991). The matched MCAM entry rule directs RX network 124 to retrieve the values of various fields in CD_DATA_IRH 510 (e.g., MSNS_Alg 520, CD_HW_SA_CTX_IDX 524, and fields for the IP offset, and the ESP offset). RX network 124 can determine the value for CD_DPtr_Offset 232 from the IP offset and can determine the ESP header from the ESP offset. Using the ESP header and MSNS_Alg 520, RX network 124 can determine the value of SNS_IDX 218. Using the determined information and the inline IPSec (inbound) configuration registers (e.g., operation code, parameters, etc.), RX network 124 constructs and sends the CPT instruction to an inline decryption local function (LF) of CPT 120.

In step 708, CPT 120 receives the CPT instruction and performs in-place IPsec inbound packet processing on the data in the buffer pointed by the CD_DPtr_Offset 232. Next, CPT 120 forms a packet with the Full Packet format and sends it to RX network 124 again for the second pass classification.

In step 710, after the second pass classification, RX network 124 delivers the packet to CPU core 122 in accordance with a second pass RSS MCAM rule.

In step 712, CPU core 122 receives the decrypted IPsec packet in the Full Packet format. CD_DATA_ORH 532 is constructed by CPU core 122 retrieving various values from a CPT parse header of the Full Packet format and encoding these values in various fields of CD_DATA_ORH 532 (e.g., HW_CC 538, MC_CC 540, CD_HW_SA_CTX_IDX 544). CPU core 122 clips CD_Data_IRH 510 from the packet and inserts in its place CD_Data_ORH 532. CPU core 122 then sends the resulting Ethernet frame, Ethernet frame 530, to TX network 126.

CD_DATA_ORH is the "Crypto Device data Output Request Header" with a beginning 8-bit match pattern 0xC2 indicating for Express Path IPsec Decryption Result (CD DATA _ORH EXP IPSEC DEC RSLT). Here is the ORH format. For details refer to the later sections

In step 714, TX network 126 transmits Ethernet frame 530 to routing device 104, where it is then forwarded to host CPU complex 102 and more particularly to PPE software running on host CPU complex 102.

In step 716, the PPE running on host CPU complex 102 receives Ethernet frame 530 and recognizes it from the EtherType 0x9991 as an express path decrypted IPsec packet that has a field CD_DATA_ORH. The PPE can then perform appropriate additional processing.

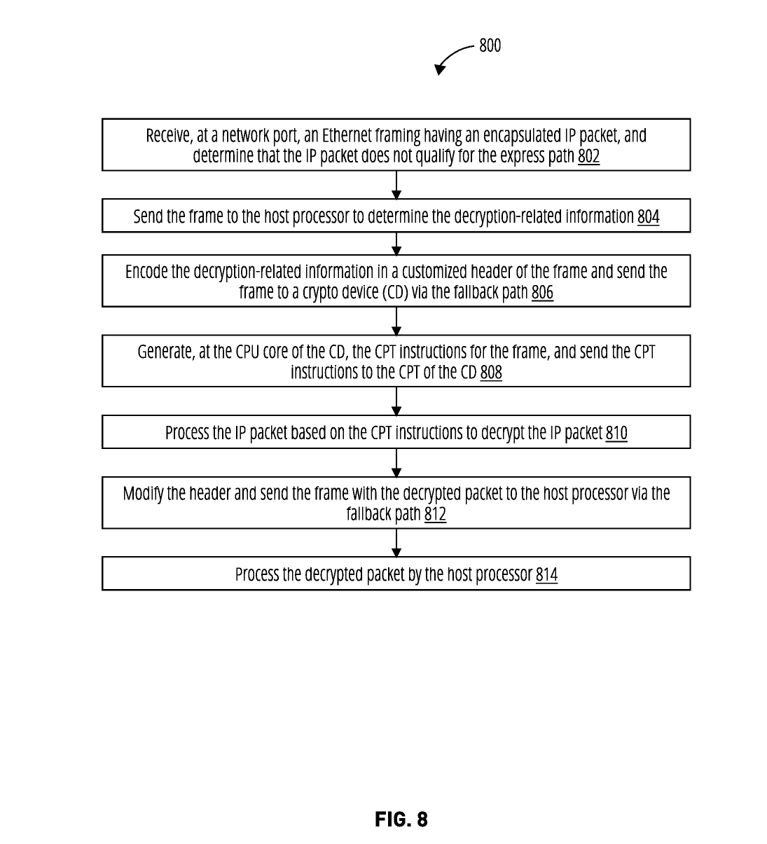

FIG. 8 illustrates an example method 800, which is a fallback method for inbound traffic. Although the example method 800 depicts a particular sequence of operations, the sequence may be altered without departing from the scope of the present disclosure. For example, some of the operations depicted may be performed in parallel or in a different sequence that does not materially affect the function of method 800. In other examples, different components of an example device or system that implements method 800 may perform functions at substantially the same time or in a specific sequence.

According to some examples, block 802 of the method includes receiving, at a network port, an ethernet framing having an encapsulated IP packet, and determining that the IP packet does not qualify for the express path. For example, routing device 104 illustrated in FIG. 1 may receive an ethernet framing having an encapsulated IP packet, and routing device 104 can determine that the IP packet does not qualify for the express path. For example, when the CTM receives an IP packet from a network port, the CTRM can classify the IP packet as non-qualified for Inbound IPsec Express Path. Based on this classification, routing device 104 sends the IP packet to host CPU complex 102 CPU via host path 134.

According to some examples, block 804 of the method includes sending the frame to the host processor to determine the decryption-related information. For example, host CPU complex 102 illustrated in FIG. 1 may receive the frame and determine the decryption-related information. PPE software running on host CPU complex 102 can classify the frame as an Inbound IPsec packet and locate the inbound IPsec SA.

According to some examples, block 806 of the method includes encoding the decryption-related information in a customized header (e.g., CD_DATA_IRH header) of the frame before sending the frame to a crypto device (CD) via the data fallback path 128. For example, host CPU complex 102 illustrated in FIG. 1 may encode the decryption-related information in the customized header of the frame before sending the frame to a crypto device (CD 110) via data fallback path 128.

According to certain non-limiting examples, the PPE constructs the CD_DATA_IRH header starting with a match pattern (e.g., in the field CD_DATA_IRH_FBP_IPSEC_DEC) indicating that the IP packet is to be processed using fallback path IPsec decryption. Further, the CD_DATA_IRH header can include an SA index, a pointer offset, and other decryption-related parameters. host CPU complex 102 inserts the CD_DATA_IRH header at the start of the IP packet, and then sends the packet to CPU core 122 of CD 110. For example, the packet can be sent to CPU core 122 via a PCIe fallback port.

According to some examples, block 808 of the method includes generating, at the host processor, the CPT instructions for the frame, and sending the CPT instructions to the CD. For example, host CPU complex 102 illustrated in FIG. 1 may generate, at the host processor, the CPT instructions for the frame, and send the CPT instructions to the CD via the.

According to certain non-limiting examples, the CPU core of the CD receives the packet and retrieves the SA index, the pointer offset (e.g., CD_DPtr_Offset 232), and other parameters from the CD_DATA_IRH header. Next, CPU core 122 constructs the CPT instruction and submits the instruction to CPT via a fallback-path-CPT local function (LF).

According to some examples, block 810 of the method includes processing the IP packet based on the CPT instructions to decrypt the IP packet. For example, CPT 120 illustrated in FIG. 1 may process the IP packet based on the CPT instructions to decrypt the IP packet.

According to certain non-limiting examples, CPT 120 processes the IP packet based on the CPT instruction, performs in-place IPsec decryption, and sends the result back CPU core 122.

According to some examples, block 812 of the method includes modifying the header and sending the frame with the decrypted packet to the host processor via the fallback path. For example, CPU core 122 illustrated in FIG. 1 may modify the header and send the frame with the decrypted packet to a PPE running on host CPU complex 102 via the data fallback path 128.

According to certain non-limiting examples, CPU core 122 receives the CPT processed packet and the CPT result. CPU core 122 uses the CPT results to construct the CD_DATA_ORH header starting with a match pattern corresponding to a fallback path IPsec decryption result (e.g., CD_DATA_FBP_IPSEC_DEC_RSLT). CPU core 122 clips and replaces the CD_DATA_IRH header by inserting the CD_DATA_ORH header at the previous location of the CD_DATA_IRH header. CPU core 122 then sends the resulting packet back to the PPE running on host CPU complex 102. For example, the resulting packet back to the PPE along data fallback path 128 via the same PCIe fallback port through which the packet was originally received.

According to some examples, block 814 of the method includes processing the decrypted packet by the host processor. For example, host CPU complex 102 illustrated in FIG. 1 may process the decrypted packet.

According to certain non-limiting examples, host CPU complex 102 receives the Ethernet frame, recognizes the frame as a fallback path decrypted IPsec packet, and forwards it to PPE software running on host CPU complex 102 for further processing.

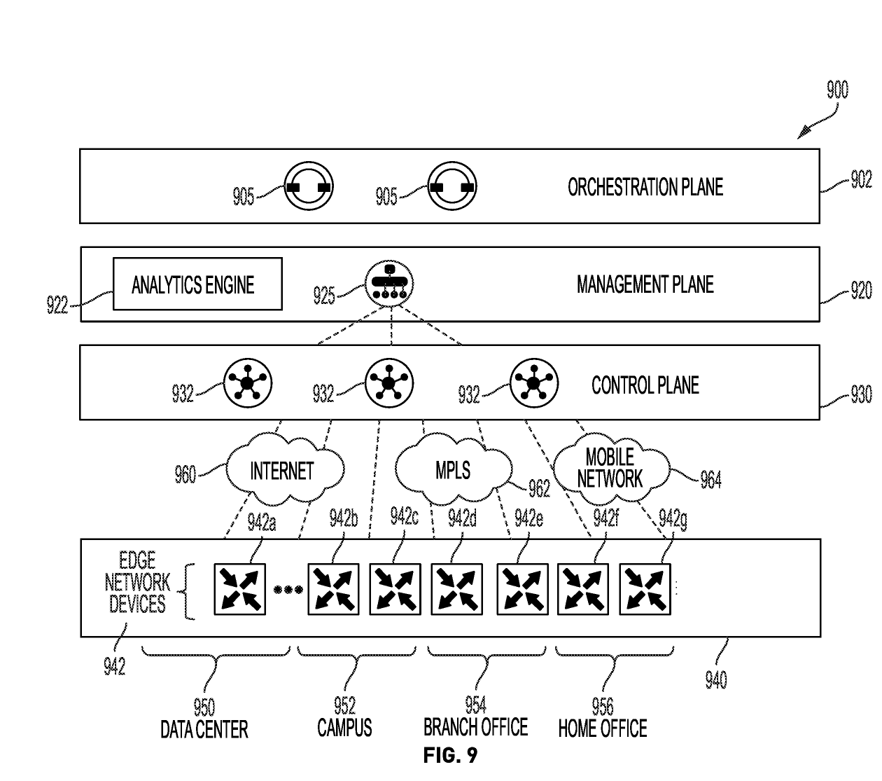

FIG. 9 illustrates an example of a network architecture 900 for implementing aspects of the present technology. An example of an implementation of the network architecture 900 is the Cisco® SD-WAN architecture. However, one of ordinary skill in the art will understand that, for the network architecture 900 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 900 can comprise an orchestration plane 902, a management plane 920, a control plane 930, and a data plane 940. The orchestration plane 902 can assist in the automatic on-boarding of edge network devices 942 (e.g., switches, routers, etc.) in an overlay network. The orchestration plane 902 can include one or more physical or virtual network orchestrator appliances. Network orchestrator appliances 905 can perform the initial authentication of edge network devices 942 (e.g., edge network devices 942a, 942b, 942c, 942d, 942e, 942f, and 942g) and orchestrate connectivity between devices of the control plane 930 and the data plane 940. In some embodiments, network orchestrator appliances 905 can also enable communication of devices located behind Network Address Translation (NAT). In some embodiments, physical or virtual Cisco® SD-WAN vBond appliances can operate as network orchestrator appliances 905.

The management plane 920 can be responsible for the central configuration and for monitoring a network. The management plane 920 can include one or more physical or virtual network management appliances. In some embodiments, network management appliances 925 can provide centralized management of the network via a graphical user interface to enable a user to monitor, configure, and maintain edge network devices 942 and links (e.g., internet transport network 960, MPLS network 962, 4G/Mobile network 964) in an underlay and overlay network. Network management appliances 925 can support multi-tenancy and enable centralized management of logically isolated networks associated with different entities (e.g., enterprises, divisions within enterprises, groups within divisions, etc.). Alternatively or additionally, network management appliances 925 can be a dedicated network management system for a single entity. In some embodiments, physical or virtual Cisco® SD-WAN vManage appliances can operate as network management appliances 925.

The control plane 930 can build and maintain a network topology and make decisions on where traffic flows. The control plane 930 can include one or more physical or virtual network control appliances. Network control appliances 932 can establish secure connections to edge network devices 942 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the Network control appliances 932 can operate as route reflectors. Network control appliances 932 can also orchestrate secure connectivity in the data plane 940 between and among edge network devices 942. For example, in some embodiments, Network control appliances 932 can distribute crypto key information among edge network devices 942. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as Network control appliances 932.

The data plane 940 can be responsible for forwarding packets based on decisions from the control plane 930. The data plane 940 can include edge network devices 942, which can be physical or virtual edge network devices. Edge network devices 942 can operate at the edges of network environments of an organization, such as in data centers 950, campus networks 952, branch office networks 954, home office networks 956, and so forth, or in the cloud (e.g., Infrastructure as a Service (IaaS), Platform as a Service (PaaS), SaaS, and other cloud service provider networks). Edge network devices 942 can provide secure data plane connectivity among sites over one or more WAN transports, such as via internet transport network 960 (e.g., Digital Subscriber Line (DSL), cable, etc.), MPLS networks 962 (or other private packet-switched network (e.g., Metro Ethernet, Frame Relay, Asynchronous Transfer Mode (ATM), etc.), mobile networks 964 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). Edge network devices 942 can be responsible for traffic forwarding, security, encryption, quality of service (QoS), and routing (e.g., BGP, OSPF, etc.), among other tasks. In some embodiments, physical or virtual Cisco® SD-WAN vEdge routers can operate as edge network devices 942.

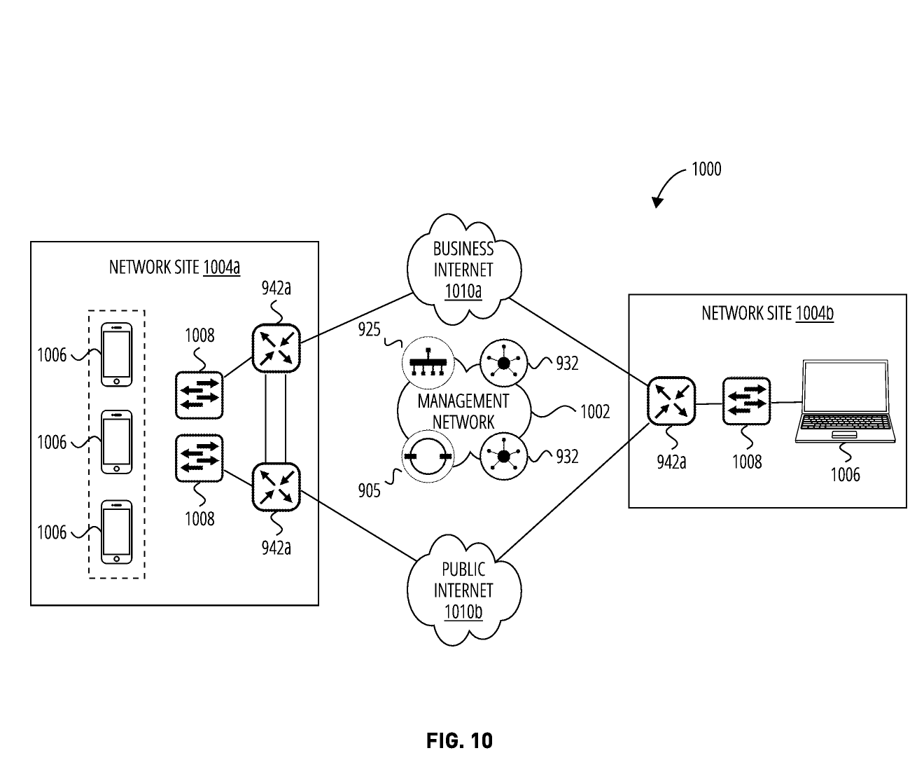

FIG. 10 illustrates an example of a network topology 1000 for showing various aspects of the network architecture 900. The network topology 1000 can include a management network 1002, a pair of network site 1004a and network site 1004b (e.g., local networks such as data centers 950, campus networks 952, branch office networks 954, home office networks 956, cloud service provider networks, etc.), and a pair of transport links such as transport network 1010a and transport network 1010b. The management network 1002 can include network orchestrator appliances 905,network management appliance 922, and Network control appliances 932. Although the management network 1002 is shown as a single network in this example, one of ordinary skill in the art will understand that each element of the management network 1002 can be distributed across any number of networks and/or be co-located with network site 1004a and network site 1004b. In this example, each element of the management network 1002 can be reached through either one of the transport links, transport network 1010a, or transport network 1010b.

Each site can include endpoints 1006 connected to site network devices 1008. The endpoints 1006 can include general purpose computing devices (e.g., servers, workstations, desktop computers, etc.), mobile computing devices (e.g., laptops, tablets, mobile phones, etc.), wearable devices (e.g., watches, glasses or other head-mounted displays (HMDs), ear devices, etc.), and so forth. The endpoints 1006 can also include Internet of Things (IoT) devices or equipment, such as agricultural equipment (e.g., livestock tracking and management systems, watering devices, unmanned aerial vehicles (UAVs), etc.); connected cars and other vehicles; smart home sensors and devices (e.g., alarm systems, security cameras, lighting, appliances, media players, HVAC equipment, utility meters, windows, automatic doors, door bells, locks, etc.); office equipment (e.g., desktop phones, copiers, fax machines, etc.); healthcare devices (e.g., pacemakers, biometric sensors, medical equipment, etc.); industrial equipment (e.g., robots, factory machinery, construction equipment, industrial sensors, etc.); retail equipment (e.g., vending machines, point of sale (POS) devices, Radio Frequency Identification (RFID) TAGs, etc.); smart city devices (e.g., street lamps, parking meters, waste management sensors, etc.); transportation and logistical equipment (e.g., turnstiles, rental car trackers, navigational devices, inventory monitors, etc.); and so forth.

The site network devices 1008 can include physical or virtual switches, routers, and other network devices. Although network site 1004a is shown including a pair of site network devices and network site 1004b is shown including a single site network device in this example, the site network devices 1008 can include any number of network devices in any network topology, including multi-tier (e.g., core, distribution, and access tiers), spine-and-leaf, mesh, tree, bus, hub and spoke, and so forth. For example, one or more data center networks may implement the Cisco® Application Centric Infrastructure (ACI) architecture and/or one or more campus networks may implement the Cisco® Software Defined Access (SD-Access or SDA) architecture. The site network devices 1008 can connect the endpoints 1006 to edge network devices 942, and the edge network devices 942 can be used to directly connect to the external networks such as internet transport network 960.

In some examples, “color” can be used to identify an individual transport network, and different transport networks may be assigned different colors (e.g., MPLS, private1, biz-internet, metro-ethernet, LTE, etc.). For example, the network topology 1000 can utilize a color called “biz-internet” for transport network 1010a and a color called “public-internet” for transport network 1010b.

In some examples, site network devices 1008 can form a Datagram Transport Layer Security (DTLS) or TLS control connection to Network control appliances 932 and connect to any Network control appliances 932 over each of transport network 1010a and transport network 1010b. In some examples, edge network devices 942 can also securely connect to edge network devices in other sites via IPSec tunnels. In some embodiments, the BFD protocol may be used within each of these tunnels to detect loss, latency, jitter, and path failures.

On edge network devices 942, color can be used help to identify or distinguish an individual transport tunnel (e.g., no same color may be used twice on a single edge network device). Colors by themselves can also have significance. For example, the colors may be private colors, which can be used for private networks or in places where there is no NAT addressing of the transport IP endpoints (e.g., because there may be no NAT between two endpoints of the same color). When edge network devices 942 use a private color, they may attempt to build IPSec tunnels to other edge network devices using native, private, underlay IP addresses. The public colors can include 3g, biz, internet, blue, bronze, custom1, custom2, custom3, default, gold, green, LTE, public-internet, red, and silver. The public colors may be used by edge network devices 942 to build tunnels to post-NAT IP addresses (if there is NAT involved). If edge network devices 942 use private colors and need NAT to communicate to other private colors, the carrier setting in the configuration can dictate whether edge network devices 942 use private or public IP addresses. Using this setting, two private colors can establish a session when one or both are using NAT.

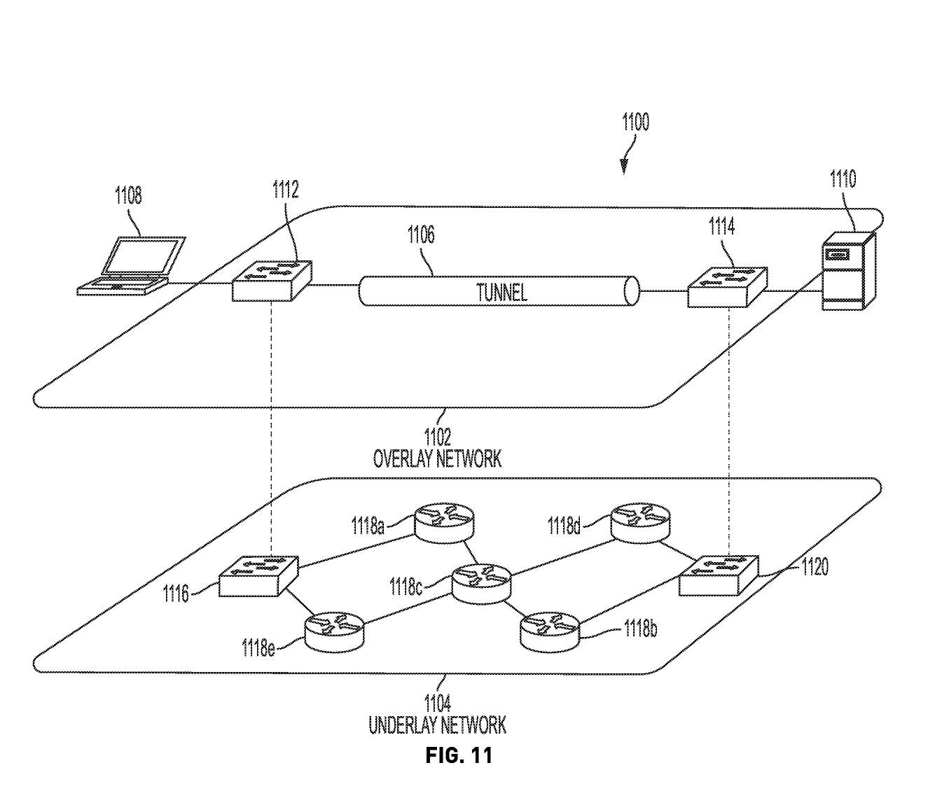

FIG. 11 illustrates a system 1100 that includes an overlay network 1102, which is a virtual network, that operates on an underlay network 1104, which is an actual, physical network. Virtual, overlay networks can be used to implement encapsulation protocols such as VXLAN packets, Generic Routing Encapsulation (GRE) or Generic UDP Encapsulation (GUE) to encapsulate data and send it through a tunnel 1106. For example, SD-WAN implementation can use IPsec UDP-based overlay network layer protocol encapsulation as defined in RFC-4023. Parts of the description of system 1100 use a non-limiting example of a VXLAN overlay network to illustrate general aspects of overlay networks. However, the systems and methods disclosed herein are not limited to a particular overlay network technology, as would be understood by a person of ordinary skill in the art..

For example, GRE is a tunneling protocol that can encapsulate a wide variety of network layer protocols inside virtual point-to-point links or point-to-multipoint links over an Internet Protocol network. GUE provides encapsulation of user data (Application layer) into a UDP datagram (Transport layer) over IP (Network layer) inside some Data link layer protocol. Generic Network Virtualization Encapsulation (Geneve) is a network encapsulation protocol created by the IETF in order to unify the efforts made by other initiatives like VXLAN and NVGRE, with the intent to eliminate the wild growth of encapsulation protocols.

In FIG. 11, overlay network 1102 can include virtual switch 1112 that corresponds to a physical switch 1116 and receives ingress data from a source node 1108 (e.g., a user device, such as a laptop or smart phone) encapsulates data and sends it through tunnel 1106 to virtual switch 1114. Virtual switch 1114 corresponds to a physical switch 1120 and decapsulates the received encapsulated data. After decapsulation, virtual switch 1114 sends data to destination node 1110 (e.g., a server).

In FIG. 11, underlay network 1104 can include a physical switch 1116, a physical switch 1120, and a series of routers (e.g., router 1118a, a router 1118b, a router 1118c, a router 1118d, and a router 1118e) that make up a network fabric.

VXLAN is a non-limiting example of network virtualization. Generally, there are many examples of network virtualization, such as GRE, GUE, and Geneve. For example, a description of Geneve can be found in RFC-8926, and IPsec UDP-based overlay network layer protocol encapsulation as defined in RFC-4023. A person of ordinary skill in the art would understand, that when the systems and methods disclosed herein use network virtualization, any of the available techniques can be used.

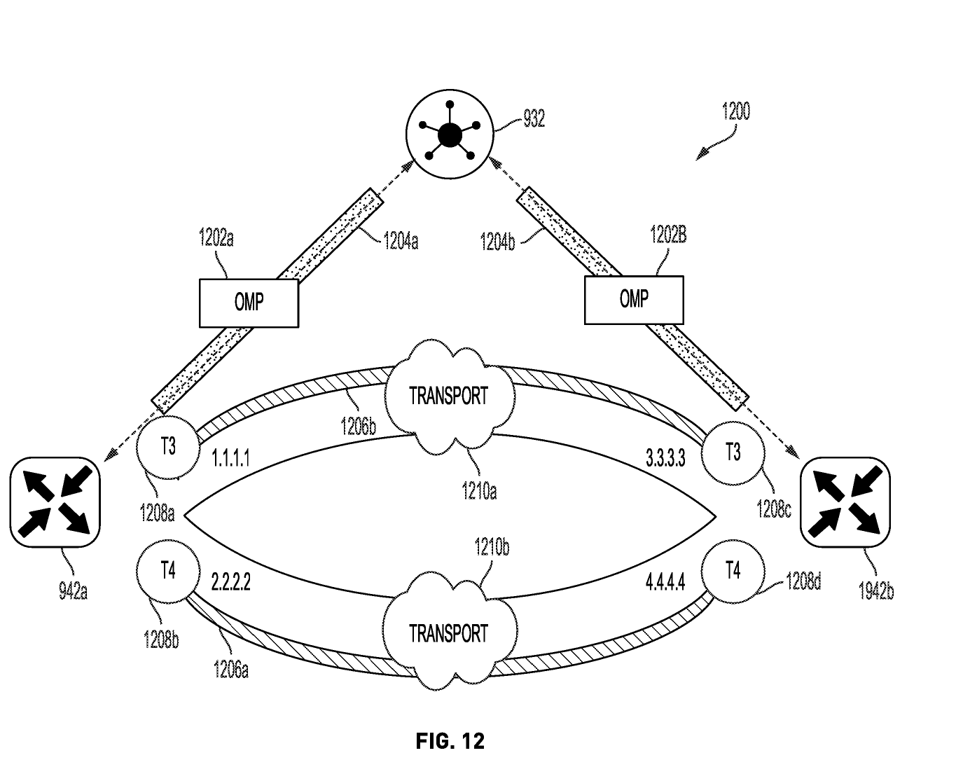

FIG. 12 illustrates an example of an overlay architecture 1200 used for an overlay management protocol (OMP), which may be used in some examples to manage an overlay of a network (e.g., the network architecture 900). In this example, OMP messages 1202a and OMP messages 1202b may be transmitted back and forth between Network control appliances 932 and edge network devices 942a and 942b, respectively, where control plane information, such as route prefixes, next-hop routes, crypto keys, policy information, and so forth, can be exchanged over respective one of secure DTLS or TLS connection 1204a and secure DTLS or TLS connection 1204b. In some examples, one or more trigger conditions used in the designation of the edge network devices 942 as primary or secondary can be based on OMP messages 1202a or OMP messages 1202b. Network control appliances 932 can operate similarly to a route reflector. For example, Network control appliances 932 can receive routes from the edge network devices 942, process and apply any policies to them, and advertise routes to other ones of edge network devices 942 in the overlay. If there is no policy defined, the edge network devices 942 may behave in a manner similar to a full mesh topology, where each edge network device can connect directly to another edge network device at another site and receive full routing information from each site.

The OMP can advertise different OMP routes. In an example, an OMP route can correspond to prefixes that are learned from the local site, or service side, of the edge network device. The prefixes can be originated as static or connected routes, or from within, for example, the OSPF or BGP protocols, and redistributed into OMP so they can be carried across the overlay. OMP routes can advertise attributes such as transport location (TLOC) information (which can be similar to a BGP next-hop IP address) and other attributes such as origin, originator, preference, site identifier, tag, and virtual private network (VPN). An OMP route may be installed in the forwarding table if the TLOC to which it points is active.

In another example, OMP routes can include TLOC routes, which can correspond to logical tunnel termination points on the edge network devices 942 that connect to one or more external networks through one or more transport links. In some embodiments, a TLOC route can be uniquely identified and represented by a three-tuple, including an IP address, link color, and encapsulation (e.g., Generic Routing Encapsulation (GRE), IPSec, etc.). In addition to system IP address, color, and encapsulation, TLOC routes can also carry attributes such as TLOC private and public IP addresses, carrier, preference, site identifier, tag, and weight. In some embodiments, a TLOC may be in an active state on a particular edge network device when an active BFD session is associated with that TLOC.

In another example, OMP routes can include Service routes, which can represent services (e.g., firewall, distributed denial of service (DDoS) mitigator, load balancer, intrusion prevent system (IPS), intrusion detection systems (IDS), WAN optimizer, etc.) that may be connected to the local sites of the edge network devices 942 and accessible to other sites for use with service insertion. In addition, these routes can also include VPNs; the VPN labels can be sent in an update type to tell Network control appliances 932 what VPNs are serviced at a remote site.

In the example of FIG. 12, OMP is shown running over TLS/DTLS connection 1204a and TLS/DTLS connection 1204b established between the edge network devices 942 and Network control appliances 932. In addition, overlay architecture 1200 shows an IPSec tunnel 1206a established between TLOC 1208a and 1208c over WAN transport link 1210a and an IPSec tunnel 1206b established between TLOC 1208b and TLOC 1208d over WAN transport link 1210b. Once the IPSec tunnels 1206a and 1206b are established, BFD can be enabled across each of them.

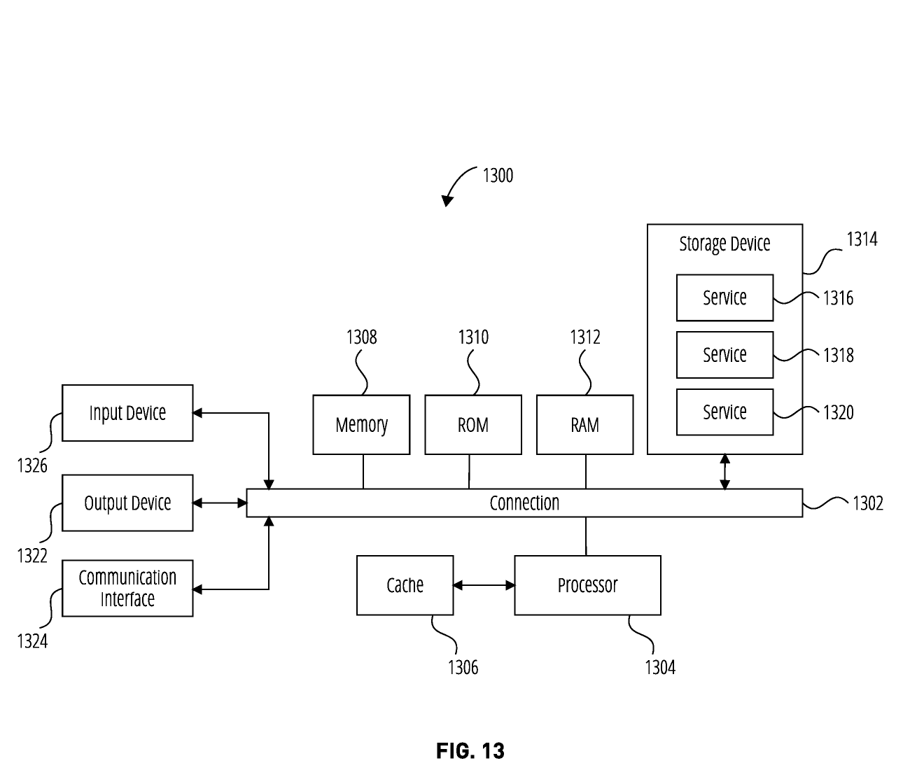

FIG. 13 shows an example of computing system 1300. The computing system 1300 can be a router, switch, network control appliance, network management appliance, or an analytics engine, for example. The computing system 1300 can perform the functions of one or more of hybrid platform 100. The computing system 1300 can be part of a distributed computing network in which several computers perform respective steps in method 300, method 600, method 800 and/or the functions of hybrid platform 100. The computing system 1300 can be connected to the other parts of the distributed computing network via connection 1302 or communication interface 1324. Connection 1302 can be a physical connection via a bus, or a direct connection into processor 1304, such as in a chipset architecture. Connection 1302 can also be a virtual connection, networked connection, or logical connection.

In some embodiments, computing system 1300 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1300 includes at least one processing unit or CPU (e.g., processor 1304) and connection 1302 that couples various system components including system memory 1308, such as read-only memory (e.g., ROM 1310) and random access memory (e.g., RAM 1312) to processor 1304. Computing system 1300 can include a cache of high-speed memory 1306 connected directly with, in close proximity to, or integrated as part of processor 1304. Processor 1304 may essentially be a completely self-contained computing system, containing multiple cores or processors, a bus, memory controller, cache, etc. A multi-core processor may be symmetric or asymmetric.

Processor 1304 can include any general-purpose processor and a hardware service or software service, such as service 1316, service 1318, and service 1320 stored in storage device 1314, configured to control processor 1304 as well as a special-purpose processor where software instructions are incorporated into the actual processor design.

To enable user interaction, computing system 1300 includes an input device 1326, which can represent any number of input mechanisms, such as a microphone for speech, a touch-sensitive screen for gesture or graphical input, keyboard, mouse, motion input, speech, etc. Computing system 1300 can also include output device 1322, which can be one or more of a number of output mechanisms known to those of skill in the art. In some instances, multimodal systems can enable a user to provide multiple types of input/output to communicate with computing system 1300. Computing system 1300 can include a communication interface 1324, which can generally govern and manage the user input and system output. There is no restriction on operating on any particular hardware arrangement, and therefore the basic features here may easily be substituted for improved hardware or firmware arrangements as they are developed.

Storage device 1314 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1314 can include software services, servers, services, etc., that when the code that defines such software is executed by the processor 1304, it causes the system to perform a function. In some embodiments, a hardware service that performs a particular function can include the software component stored in a computer-readable medium in connection with the necessary hardware components, such as processor 1304, connection 1302, output device 1322, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a component of hybrid platform 100 and performs one or more functions of method 300, method 600, and method 800 when a processor executes the software associated with the service. In some embodiments, a service is a program or a collection of programs that carry out a specific function. In some embodiments, a service can be considered a server. The memory can be a non-transitory computer-readable medium.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method for efficiently processing network data packets, the method comprising:
classifying, at a classification processor, a security association of a data packet based on one or more characteristics of the data packet;
encoding, in a header of the data packet, cryptograph information representing the security association;
sending, to a crypto device from the classification processor, the data packet together with the cryptograph information in the header of the data packet;
performing, by a cryptography processor of the crypto device, a cryptography operation on the data packet based on the cryptograph information in the header of the data packet; and
removing the cryptograph information from the header of the data packet before transmitting the data packet to a destination of the data packet.

2. The method of claim 1, wherein removing the cryptograph information from the header of the data packet is performed by the crypto device after performing the cryptography operation.

3. The method of claim 1, wherein:
the data packet is part of inbound traffic received at a hybrid platform for packet processing, and
the hybrid platform comprises a general processor, a routing device, and a hardware accelerator comprising the crypto device, wherein the general processor is programmed with packet processing software.

4. The method of claim 1, wherein:
the data packet is part of inbound traffic,
the cryptography operation comprises decrypting a payload of the data packet using the security association,
the classification processor comprises a matching engine that is indexed based on the one or more characteristics of the data packet and outputs the security association and decryption information that is used to decrypt the payload of the data packet, and
the destination comprises one or more packet processing elements being executed by one or more host processors, the one or more packet processing elements being configured to perform packet processing operations on an unencrypted payload of the data packet.

5. The method of claim 4, wherein:
the one or more characteristics of the data packet an 5-tuple of the data packet and a security parameter index (SPI), and
the matching engine comprises a content addressable memory (CAM) that, in response to the one or more characteristics of the data packet matching a CAM entry, output a CAM entry rule causing the classification processor to determine the cryptograph information that is encoded in the header of the data packet.

6. The method of claim 1, wherein:
the data packet is part of outbound traffic,
the cryptography operation comprises encrypting a payload of the data packet using the security association,
the classification processor comprises a one or more packet processing elements being executed by one or more host processors, the one or more packet processing elements encoding the cryptograph information in the header of the data packet, and
the destination is a network node indicated by a destination address in the header of the data packet.

7. The method of claim 1, wherein:
the data packet comprises an Ethernet frame encapsulating a payload comprising an Internet protocol (IP) packet, and
the security association includes information of an IP security (IPSec) tunnel.

8. The method of claim 1, wherein:
the data packet is part of inbound traffic,
the cryptography operation comprises decrypting a payload of the data packet using the security association, and
the method further comprises:
determining, at a routing device, that the data packet is not qualified for decrypting the payload using an express path,
transmitting, from the routing device to one or more packet processing elements running on one or more host processors, the data packet, the one or more packet processing elements comprising the classification processor,
performing, by the cryptography processor, the decrypting of the payload to provide the data packet with an unencrypted payload, and
removing the cryptograph information from the header of the data packet with the unencrypted payload before transmitting the data packet to the destination, wherein the destination is the one or more packet processing elements running on the one or more host processors.

9. A computing system comprising:
one or more processors; and
a memory storing instructions that, when executed by the one or more processors, configure the computing system to:
classify, at a classification processor, a security association of a data packet based on one or more characteristics of the data packet;
encode, in a header of the data packet, cryptograph information representing the security association;
send, to a crypto device from the classification processor, the data packet together with the cryptograph information in the header of the data packet;
perform, by a cryptography processor of the crypto device, a cryptography operation on the data packet based on the cryptograph information in the header of the data packet; and
remove the cryptograph information from the header of the data packet before transmit the data packet to a destination of the data packet.

10. The computing system of claim 9, wherein removing the cryptograph information from the header of the data packet is performed by the crypto device after performing the cryptography operation.

11. The computing system of claim 9, wherein:
the classification processor comprises a first classifier for inbound traffic and a second classifier for outbound traffic, and
the one or more processors comprises a hybrid platform that comprises:
a routing device including the first classifier, which is configured to classify security associations for the inbound traffic,
a hardware accelerator comprising the crypto device, and
a programmable processor that is programmed to execute one or more packet processing elements, the one or more packet processing elements comprising the second classifier, and the second classifier configured to classify security associations for the outbound traffic.

12. The computing system of claim 9, wherein:
the data packet is part of inbound traffic,
the cryptography operation comprises decrypting a payload of the data packet using the security association,
the classification processor comprises a matching engine that is indexed based on the one or more characteristics of the data packet and outputs the security association and decryption information that is used to decrypt the payload of the data packet, and
the destination comprises one or more packet processing elements being executed by one or more host processors, the one or more packet processing elements being configured to perform packet processing operations on an unencrypted payload of the data packet.

13. The computing system of claim 12, wherein:
the one or more characteristics of the data packet a 5-tuple of the data packet and a security parameter index (SPI), and
the matching engine comprises a content addressable memory (CAM) that, in response to the one or more characteristics of the data packet matching a CAM entry, output a CAM entry rule causing the classification processor to determine the cryptograph information that is encoded in the header of the data packet.

14. The computing system of claim 9, wherein:
the data packet is part of outbound traffic,
the cryptography operation comprises encrypting a payload of the data packet using the security association,
the classification processor comprises a one or more packet processing elements being executed by one or more host processors, the one or more packet processing elements encoding the cryptograph information in the header of the data packet, and
the destination is a network node indicated by a destination address in the header of the data packet.

15. The computing system of claim 9, wherein:
the data packet comprises an Ethernet frame encapsulating a payload comprising an Internet protocol (IP) packet, and
the security association includes information of an IP security (IPSec) tunnel.

16. The computing system of claim 9, wherein:
the data packet is part of inbound traffic,
the cryptography operation comprises decrypting a payload of the data packet using the security association, and
the instructions further configure the computing system to:
determine, at a routing device, that the data packet does not qualify for decrypting the payload using an express path,
transmit, from the routing device to one or more packet processing elements running on one or more host processors, the data packet, the one or more packet processing elements comprising the classification processor,
perform, by the cryptography processor, the decrypting of the payload to provide the data packet with an unencrypted payload, and
remove the cryptograph information from the header of the data packet with the unencrypted payload before transmitting the data packet to the destination, wherein the destination is the one or more packet processing elements running on the one or more host processors.

17. A non-transitory computer-readable storage medium comprising instructions that when executed by a computing system, cause the computing system to:
classify, at a classification processor, a security association of a data packet based on one or more characteristics of the data packet;
encode, in a header of the data packet, cryptograph information representing the security association;
send, to a crypto device from the classification processor, the data packet together with the cryptograph information in the header of the data packet;
perform, by a cryptography processor of the crypto device, a cryptography operation on the data packet based on the cryptograph information in the header of the data packet; and
remove the cryptograph information from the header of the data packet before transmit the data packet to a destination of the data packet.

18. The non-transitory computer-readable storage medium of claim 17, wherein:
the data packet is part of inbound traffic,
the cryptography operation comprises decrypting a payload of the data packet using the security association,
the classification processor comprises a classification matching engine that is indexed based on the one or more characteristics of the data packet and outputs the security association and decryption information that is used to decrypt the payload of the data packet, and
the destination comprises one or more packet processing elements being executed by one or more host processors, the one or more packet processing elements being configured to perform packet processing operations on an unencrypted payload of the data packet.

19. The non-transitory computer-readable storage medium of claim 17, the data packet is part of outbound traffic,
the cryptography operation comprises encrypting a payload of the data packet using the security association,
the classification processor comprises a one or more packet processing elements being executed by one or more host processors, the one or more packet processing elements encoding the cryptograph information in the header of the data packet, and
the destination is a network node indicated by a destination address in the header of the data packet.

20. The non-transitory computer-readable storage medium of claim 17, wherein:
the data packet is part of inbound traffic,
the cryptography operation comprises decrypting a payload of the data packet using the security association, and
the instructions cause the computing system to:
determine, at a routing device, that the data packet is not qualified for decrypting the payload using an express path,
transmit, from the routing device to one or more packet processing elements running on one or more host processors, the data packet, the one or more packet processing elements comprising the classification processor,
perform, by the cryptography processor, the decrypting of the payload to provide the data packet with an unencrypted payload, and
remove the cryptograph information from the header of the data packet with the unencrypted payload before transmitting the data packet to the destination, wherein the destination is the one or more packet processing elements running on the one or more host processors.
